(19) United States
(12) Patent Application Publication
(10) Pub. No.: US 2025/0167934 A1
(43) Pub. Date: May 22, 2025

(54) Wireless Device, Network Node, and Methods Performed Thereby, for Handling Transmission

(71) Applicant: Telefonaktiebolaget LM Ericsson (publ), Stockholm (SE)

(72) Inventors: Jan Christoffersson, Luleå (SE); Henrik Enbuske, Stockholm (SE)

(21) Appl. No.: 18/837,645

(22) PCT Filed: Feb. 13, 2023
(86) PCT No.: PCT/SE2023/050118

§ 371 Date: Aug. 12, 2024

Related U.S. Application Data
(60) Provisional application No. 63/267,944, filed on Feb. 14, 2022.

(51) Int. Cl. H04L 5/00; H04L 1/1812; H04L 1/1867; H04W 28/02; H04W 74/0833

(52) U.S. Cl. CPC H04L 5/0005; H04L 1/1812; H04L 1/1896; H04W 28/0278; H04W 74/0833

(57) ABSTRACT

A method performed by a wireless device (130). The wireless device (130), after a first transmission of first data in a first subset of a set of periodic uplink time-frequency resources to a network node (110), and in the absence of having received an acknowledgement that the first data has been received, selects (204) a procedure for sending (205) a second transmission from: i) a HARQ retransmission, ii) an initial transmission comprising a same message to resume communications, iii) the initial transmission comprising the same message to resume communications and at least one of: a MAC PDU, an updated MAC PDU, an updated report on the status of the buffer, and an updated report on the power, and iv) an RA or RA-SDT for the transmission of the data. The wireless device (130) also sends (203) the second transmission to the network node (110) in a second subset of the set.

### TECHNICAL FIELD

The present disclosure relates generally to a wireless device and methods performed thereby for handling transmission. The present disclosure further relates generally to a first network node and methods performed thereby, for handling transmission.

### BACKGROUND

Wireless devices within a wireless communications network may be e.g., User Equipments (UE), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., 5G Node B (gNB), evolved Node B (“eNB”), “eNodeB”, “NodeB”, “B node”, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

### Internet of Things (IoT)

The Internet of Things (IoT) may be understood as an internetworking of communication devices, e.g., physical devices, vehicles, which may also be referred to as “connected devices” and “smart devices”, buildings and other items-embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices is expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is a self and/or automatically controlled unattended machine and that is typically not associated with an active human user in order to generate data traffic. An MTC device may be typically simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

Fifth Generation (5G) is the fifth generation of cellular technology and was introduced in Release 15 of the 3GPP standard. It is designed to increase speed, reduce latency, and improve flexibility of wireless services. The 5G system (5GS) may include both a Next Generation Radio Access Network (NG-RAN) which may make use of a new air interface called New Radio (NR), and a new core network 5G Core (5GC), which may be referred to as Next Generation Core Network (CN), abbreviated as NG-CN, NGC or 5G CN. NG may be understood as the interface/reference point between the RAN and the CN in 5G/NR.

### NR Small Data Transmissions in Inactive State

A new Work Item (WI) RP-210870 ‘New Work Item on NR small data transmissions in INACTIVE state’ has been approved in 3GPP with the focus of optimizing the transmission for small data payloads by reducing the signaling overhead. The WI contains the following relevant objectives. The work item enables small data transmission in Radio Resource Control (RRC)_INACTIVE state as follows. For the RRC_INACTIVE state, Uplink (UL) small data transmissions for Random Access CHannel (RACH)-based schemes, that is, 2-step and 4-step RACH. A first particular objective for this first point is to provide for a general procedure to enable transmission of small data packets from INACTIVE state, e.g., using message A (MSGA) or message 3 (MSG3) [RAN2]. A second particular objective for this first point is to enable flexible payload sizes larger than the Rel-16 Common Control Channel (CCCH) message size that may be possible currently for INACTIVE state for MSGA and MSG3 to support user plane (UP) data transmission in uplink, actual payload size may be up to network configuration [RAN2]. A third particular objective for this first point is to provide for context fetch and data forwarding, with and without anchor relocation, in INACTIVE state for RACH-based solutions [RAN2, RAN3]. It has been noted that the security aspects of the above solutions may need to be checked with SA3. The work item also enables small data transmission in Radio Resource Control (RRC)_INACTIVE state as follows. Transmission of UL data on pre-configured Physical Uplink Shared Channel (PUSCH) resources, e.g., reusing the configured grant type 1, when Time Alignment (TA) may be valid. A first particular objective for this second point is to provide for a general procedure for small data transmission over configured grant type 1 resources from INACTIVE state [RAN2]. A second particular objective for this first point is to enable a configuration of the configured grant type1 resources for small data transmission in UL for INACTIVE state [RAN2]. Particularly, to specify Radio Resource Management (RRM) core requirements for small data transmission in RRC_INACTIVE, if needed [RAN4].

For NarrowBand IoT (NB-IoT) and LTE for Machines (LTE-M), similar signaling optimizations for small data have been introduced through Rel-15 Early Data Transmission (EDT) and Rel-16 Preconfigured Uplink Resources (PUR). The main difference for the NR Small Data Transmission (SDT) solutions may understood to be that the Rel-17 NR Small Data may have only to be supported for RRC INACTIVE state, may include also 2-step Random Access CHannel (RACH) based small data transmissions, and that it may also include regular complexity Mobile Broadband (MBB) UEs. Both may support mobile originated (MO) traffic only. NR SDT also, unlike LTE EDT, may support transmission of subsequent data, that is, larger payload sizes which may require more than one transmission.

### The Configured Grant (CG)-SDT Procedure

The CG-SDT procedure may use CG PUSCH resources that may be PUSCH resources configured in advance for the UE. When there may be uplink data available at the UE's buffer, it may immediately start uplink transmission using the pre-configured PUSCH resources without waiting for an UL grant from the gNB, thus reducing the latency. NR may support CG type 1 PUSCH transmission and CG type 2 PUSCH transmission. For both of the two types, the PUSCH resources, time and frequency allocation, periodicity, etc., may be preconfigured via dedicated RRC signaling. The CG type 1 PUSCH transmission may be activated/deactivated by RRC signaling, while the CG type 2 PUSCH transmission may be activated/deactivated by an UL grant using downlink control information (DCI) signaling. For Small Data transmissions, it has been agreed that the CG type 1 may be used.

According to the RAN2 agreements for CG-SDT, the CG-SDT configuration may be sent to the UE in the RRCRelease message, and may specify associations between CG resources, e.g., transmission opportunities, and Synchronization Signal Blocks (SSBs). The UE may, upon initiating the CG-SDT procedure, select a Synchronization Signal Block (SSB) with Synchronization Signal (SS)-Reference Signal Received Power (RSRP) above a configured RSRP threshold. The initial CG-SDT transmission may contain the RRCResumeRequest multiplexed with data and possibly a Buffer Status Report (BSR) Medium Access Control (MAC) Control Element (CE) and possibly a Power Headroom Report (PHR) MAC CE. If the gNB receives the transmission successfully, it may reply with dynamic scheduling of uplink new transmission for the same Hybrid Automatic Repeat reQuest (HARQ) process as acknowledgement or possibly with a Downlink (DL) data transmission. After this, the UE may use the following CG-SDT resources for transmission of new UL data after successful TA validation and SSB selection. The TA validation may be understood to mean that the CG-SDT TA timer is running and the change of the Synchronization Signal (SS)-RSRP(s) may be understood to be within configured thresholds. The CG-SDT procedure may terminate when the CG-SDT-TA timer expires, the UE reselects to a different cell or the gNB sends a RRCResume or RRCRelease to the UE.

In RAN2 #113-e, the following relevant agreements were made. As a first agreement, CG-SDT resource configuration may be provided to UEs in RRC_Connected only within the RRCRelease message, that is, there may be no need to also include it in RRCReconfiguration message. As a second agreement, CG-PUSCH resources may be separately configured for Normal UL (NUL) and Supplementary UL (SUL). For further Study (FFS) if they may be allowed at the same time. This may depend on the alignments Change Requests (CRs) for Rel-16. As a third agreement, an RRCRelease message may be used to reconfigure or release the CG-SDT resources while UE is in RRC_INACTIVE. As a fourth agreement, for CG-SDT, the subsequent data transmission may use the CG resource or Dynamic Grant (DG), that is, dynamic grant addressed to the UE's Cell Radio Network Temporary Identifier (C-RNTI). Details on C-RNTI, may be the same as the previous C-RNTI, that is, the C-RNTI that the UE may have been assigned when it was in connected mode, before being released to inactive, or may be configured explicitly by the network may be discussed in stage 3. As a fifth agreement, Timing Advance Timer (TAT)-SDT may be started upon receiving the TAT-SDT configuration from the gNB, that is, RRCrelease message, and may be (re)started upon reception of a TA command. As a sixth agreement, from RAN2 point of view, it may be assumed similar to PUR, that a TA validation mechanism for SDT may be introduced based on RSRP change, that is, RSRP-based threshold(s) may be configured. Ask RAN1 to confirm. FFS on how to handle CG configuration when TA expires or when is invalid due to RSRP threshold. Details of the TA validation procedure may be further discussed. As a seventh agreement, as a baseline assumption, it may be understood to be a network configuration issue whether to support multiple CG-SDT configurations per carrier in RRC_INACTIVE, that is, there may be no restriction to network configuration for now. As an eighth agreement, FFS discuss further in stage 3 how to specify the agreement that CG-SDT resources may be only valid in one cell, that is, the cell in which RRCRelease may be received. As a ninth agreement, a UE may release CG-SDT resources when the TAT may expire in RRC_Inactive state. As a thirteenth agreement, RAN2 design may assume that an RRCRelease message may be sent at the end to terminate the SDT procedure from the RRC point of view. The RRCRelease sent at the end of the SDT may contain the CG resource, as per previous agreement. Write a Liaison Statement (LS) to 3GPP Technical Specification Group Service and System Aspects Working Group 3 Security and Privacy (SA3) to explain SDT procedure and agreement. As a seventeenth agreement, FFS also whether this RSRP threshold to select between SDT and non-SDT procedure may be used for CG-SDT, Random Access (RA)-SDT, or both and whether the RSRP threshold may be the same for CG-SDT and RA-SDT. FFS when the RSRP threshold check may be made. As an eighteenth agreement, FFS if both carriers may be selected and CG resources are available on one carrier only, does the UE select the carrier with CG? As a nineteenth agreement, for SDT, the UE may perform UL carrier selection, that is, if SUL is configured in the cell, the UL carrier may be selected based on RSRP threshold. FFS whether the RSRP threshold for carrier selection is specific to SDT. As a twentieth agreement, if CG-SDT resources are configured on the selected UL carrier and are valid, then CG-SDT may be chosen.

In RAN2 #113bis-e, the following relevant agreements were made. As a first agreement, RSRP threshold to select between SDT and non-SDT procedure may be the same for both CG-SDT and RA-SDT. As a seventh agreement, the data volume threshold may be the same for CG-SDT and RA-SDT, may be checked further in stage 3 if majority support is obtained. As a tenth agreement, FFS that switching from CG-SDT to RA-SDT is not allowed. As a twenty-eighth agreement, CG-SDT resources may be configured at the same time on NUL and SUL.

As a twenty-ninth agreement, implicit release of CG-SDT resource is not supported. As a thirtieth agreement, the UE may start a window after CG/DG transmission for CG-SDT. FFS whether to design a new timer or to reuse an existing timer. As a thirty-first agreement, support retransmission by dynamic grant for CG-SDT. As a thirty-second agreement, support multiple HARQ processes for uplink CG-SDT. As a thirty-third agreement, CG resource availability delay is not considered as a criterion for CG validation. As a thirty-fourth agreement, UL carrier selection may be performed before CG-SDT selection. As a thirty-fifth agreement, FFS whether CG-SDT resource may be configured on BandWidthParts (BWPs) other than the initial BWP.

At RAN2 #116-ebis, the following agreements were made. As a first agreement, the legacy TAT, that is, timeAlignmentTimerCommon in System Information Block (SIB), may be used for UL timing maintenance during RA-SDT procedure. (21/23). As a second agreement, the legacy TAT, that is, timeAlignmentTimerCommon in SIB, may start/restart when Random Access Response (RAR) TAC or TAC MAC CE is received, regardless of SDT procedure. No specification change may be needed. (23/23). As a third agreement, CG-SDT resource is not released even if the legacy TAT expires. (23/23).

At RAN2 #116-ebis, the following agreements were also made. As a first agreement, RSRP-based TA validation may be only applicable for initial CG-SDT and not needed for retransmission of the initial CG-SDT. As a second agreement, no additional n-TimingAdvanceOffset (NTA) is defined for CG-SDT procedure. As a third agreement, upon expiry of CG-SDT-TAT, a UE may need to (a) clear all SDT configured grant, (b) flush HARQ buffer and (c) continue to maintain NTA. As a fourth agreement, stick to the previous agreement: subsequent new transmission on CG-SDT may be supported. Support Acknowledgement (ACK) for first Transport Block (TB) by dynamic scheduling of uplink new transmission for the same HARQ process, as in legacy, no new mechanisms. As a fifth agreement, for subsequent TB on CG, UE initiated retransmission is not supported. Dynamic scheduling may be supported as in legacy. As a sixth agreement, subsequent downlink transmission may serve as an implicit acknowledgement for initial CG-SDT but not for subsequent CG-SDT. As a seventh agreement, ConfiguredGrantTimer may be reused for CG-SDT for prohibiting the HARQ process for new uplink transmissions. That is, when the ConfiguredGrantTimer may be running, it may not be used for transmissions of new data, the old data may be kept in the buffer for possible retransmissions. As an eighth agreement, do not perform SSB reselection for retransmission for initial CG-SDT. As a ninth agreement, Configured Scheduling (CS)-Radio Network Temporary Identifier (RNTI) for CG-SDT may be provided to the UE in RRCRelease message. As a tenth agreement, UE does not perform UL carrier reselection for subsequent CG-SDT transmission over CG-SDT resources within one CG-SDT procedure. As an eleventh agreement, once an UL carrier is selected for a specific CG-SDT transmission, the UE may need to perform autonomous retransmission on the same uplink carrier on initial CG. As a twelfth agreement, there is no restriction on the candidate values of CG period. FFS on values for CG periods and time offset. As a thirteenth agreement, do not support multiple CG occasions per CG period. As a fourteenth agreement, if (a) the thresholds for SSB selection and SSB subset selection for TA-validation are different and (b) the highest beam measurement is below the configured threshold, the beam with the highest beam measurement value may be used for TA validation. As a fifteenth agreement, CG-SDT timer for initial transmission may need to be stopped when Physical Downlink Control Channel (PDCCH) addressed to Cell Radio Network Temporary Identifier (C-RNTI) and CS-RNTI may be received. When the timer expires, the UE may be allowed to retransmit for initial CG. CG-SDT may be used for controlling retransmissions. As a sixteenth agreement, a UE may not use RA-SDT resources during an ongoing CG-SDT session.

Existing methods to perform transmissions of data may incur in long connectivity interruption, higher power consumption and higher signaling overhead on both, the network and the UE.

### SUMMARY

As part of the development of embodiments herein, one or more challenges with the existing technology will first be identified and discussed.

When the first initial CG-SDT transmission, including the RRCResumeRequest message, has been performed by a UE, an acknowledgement from the network may be needed before the UE may be able to continue with new transmissions of subsequent data. It has been agreed that either DL traffic or dynamic scheduling of uplink new transmission for the same HARQ process may be considered as acknowledgement for the initial SDT transmission. Before this acknowledgement has been received, the UE may do retransmission for the initial CG-SDT. It has not yet been specified how this may need to be done. In 3GPP it has been discussed whether the redundancy version (RV) of the HARQ retransmissions may have to be specified.

Certain aspects of the present disclosure and their embodiments may provide solutions to these or other challenges.

It is therefore an object of embodiments herein to improve the handling of transmission between a network node and a wireless device in a wireless communications network.

According to a first aspect of embodiments herein, the object is achieved by a method, performed by a wireless device. The method is for handling transmission. The wireless device operates in a wireless communications network. After a first transmission of first data in a first subset of a set of periodic uplink time-frequency resources for uplink communication to a network node, wherein a size of a buffer of the wireless device for the uplink transmission of the first data is smaller than a threshold, and, in the absence of having received an acknowledgement from the network node that the first data has been received, the wireless device selects a procedure for sending a second transmission to the network node. The procedure is one of: i) a HARQ retransmission, ii) an initial transmission comprising a same message to resume communications as a message to resume communications comprised in the first transmission, iii) the initial transmission comprising the same message to resume communications and at least one of: a MAC PDU, an updated MAC PDU, an updated report on a status of the buffer of the wireless device with respect to a report on the status of the buffer of the wireless device comprised in the first transmission, and an updated report on the power of the wireless device with respect to a report on the power of the wireless device comprised in the first transmission, and iv) a random access or random access of small data transmission for the transmission of the data. The wireless device then sends the second transmission to the network node. The sending of the second transmission is in a second subset of the set of periodic uplink time-frequency resources. The second subset is a next subset of the first subset.

According to a second aspect of embodiments herein, the object is achieved by a method, performed by the network node. The method is for handling transmission. The network node operates in the wireless communications network. The network node sends the configuration to the wireless device. The wireless device is to perform the selection based on the configuration. The selection is of the procedure for, after the first transmission by the wireless device of the first data in the first subset of the set of periodic uplink time-frequency resources for uplink communication to the network node, wherein the size of the buffer of the wireless device for the uplink transmission of the first data is smaller than the threshold, and, in the absence of having received an acknowledgement from the network node that the first data has been received, sending the second transmission to the network node. The procedure is one of: i) the HARQ retransmission, ii) the initial transmission comprising the same message to resume communications as the message to resume communications comprised in the first transmission, iii) the initial transmission comprising the same message to resume communications and at least one of: the MAC PDU, the updated MAC PDU, the updated report on the status of the buffer of the wireless device with respect to the report on the status of the buffer of the wireless device comprised in the first transmission, and the updated report on the power of the wireless device with respect to the report on the power of the wireless device comprised in the first transmission, and iv) the random access or random access of small data transmission for the transmission of the data.

According to a third aspect of embodiments herein, the object is achieved by the wireless device. The wireless device may be understood to be for handling transmission. The wireless device is configured to operate in the wireless communications network. The wireless device is further configured to, after the first transmission of the first data in the first subset of the set of periodic uplink time-frequency resources for uplink communication to the network node, wherein the size of the buffer of the wireless device for the uplink transmission of the first data is configured to be smaller than the threshold, and, in the absence of having received an acknowledgement from the network node that the first data has been received, select the procedure for sending the second transmission to the network node. The procedure is configured to be one of: i) the HARQ retransmission, ii) the initial transmission configured to comprise the same message to resume communications as the message to resume communications configured to be comprised in the first transmission, iii) the initial transmission being configured to comprise the same message to resume communications and at least one of: the MAC PDU, the updated MAC PDU, the updated report on the status of the buffer of the wireless device with respect to the report on the status of the buffer of the wireless device configured to be comprised in the first transmission, and the updated report on the power of the wireless device with respect to the report on the power of the wireless device configured to be comprised in the first transmission, and iv) the random access or random access of small data transmission for the transmission of the data. The wireless device is also configured to send the second transmission to the network node. The sending of the second transmission is configured to be in the second subset of the set of periodic uplink time-frequency resources. The second subset is configured to be the next subset of the first subset.

According to a fourth aspect of embodiments herein, the object is achieved by the network node. The network node may be understood to be for handling transmission. The network node is configured to operate in the wireless communications network. The network node is configured to send the configuration to the wireless device. The wireless device is to perform the selection based on the configuration. The selection is configured to be of the procedure for, after the first transmission by the wireless device of the first data in the first subset of the set of periodic uplink time-frequency resources for uplink communication to the network node, wherein the size of the buffer of the wireless device for the uplink transmission of the first data is configured to be smaller than the threshold, and, in the absence of having received the acknowledgement from the network node that the first data has been received, sending the second transmission to the network node. The procedure is configured to be one of: i) the HARQ retransmission, ii) the initial transmission configured to comprise the same message to resume communications as the message to resume communications configured to be comprised in the first transmission, iii) the initial transmission being configured to comprise the same message to resume communications and at least one of: the MAC PDU, the updated MAC PDU, the updated report on the status of the buffer of the wireless device with respect to the report on the status of the buffer of the wireless device configured to be comprised in the first transmission, and the updated report on the power of the wireless device with respect to the report on the power of the wireless device configured to be comprised in the first transmission, and iv) the random access or random access of small data transmission for the transmission of the data.

By, in the absence of having received an acknowledgement from the network node that the first data has been received, selecting the procedure for sending the second transmission to the network node, the wireless device may be enabled to, in contrast to existing methods, not need to wait for an acknowledgement from the network node before being able to retransmit the first transmission or continue with new transmissions of subsequent data. By selecting the procedure, the wireless device may be then enabled to perform efficient retransmissions of the first transmission, e.g., the initial CG-SDT transmission, and to do in a manner that may be most optimal, given the circumstances that may apply at any given moment, e.g., based on for example, if additional, second data, may have arrived, and/or based on the priority this new, second data. Embodiments herein may be understood to enhance the performance of CG-SDT by also allowing rebuilding for retransmissions, optionally also including the additional data.

By the wireless device sending the second transmission to the network node in the next subset of the first subset, using the selected procedure, the wireless device may perform efficient retransmissions of the first transmission, e.g., the initial CG-SDT transmission, and to do in a manner that may be most optimal, given the circumstances that may apply at any given moment.

By the network node sending the configuration to the wireless device, wherein the wireless device is to perform a selection based on the configuration, the network node may enable the wireless device to, after the first transmission of data to the network node may not have been acknowledged, select the method for retransmission. As, in contrast to existing methods, the wireless device may not need to wait for an acknowledgement from the network node before the wireless device may be able to retransmit the first transmission or continue with new transmissions of subsequent data, the sending of the configuration may be understood to enable the wireless device to perform efficient retransmissions of the first transmission, e.g., the initial CG-SDT transmission.

### BRIEF DESCRIPTION OF THE DRAWINGS

Examples of embodiments herein are described in more detail with reference to the accompanying drawings, according to the following description.

FIG. 1 is a schematic diagram an example of a wireless communications network, according to embodiments herein.

FIG. 2 is a flowchart depicting a method in a wireless device, according to embodiments herein.

FIG. 3 is a flowchart depicting a method in a network node, according to embodiments herein.

FIG. 4 is a schematic block diagram illustrating two embodiments, in panel a) and panel b), of a wireless device, according to embodiments herein.

FIG. 5 is a schematic block diagram illustrating two embodiments, in panel a) and panel b), of a network node, according to embodiments herein.

FIG. 6 is a flowchart depicting a method in a wireless device, according to examples related to embodiments herein.

FIG. 7 is a flowchart depicting a method in a network node, according to examples related to embodiments herein.

FIG. 8 is a schematic block diagram illustrating a telecommunication network connected via an intermediate network to a host computer, according to embodiments herein.

FIG. 9 is a generalized block diagram of a host computer communicating via a base station with a user equipment over a partially wireless connection, according to embodiments herein.

FIG. 10 is a flowchart depicting embodiments of a method in a communications system including a host computer, a base station and a user equipment, according to embodiments herein.

FIG. 11 is a flowchart depicting embodiments of a method in a communications system including a host computer, a base station and a user equipment, according to embodiments herein.

FIG. 12 is a flowchart depicting embodiments of a method in a communications system including a host computer, a base station and a user equipment, according to embodiments herein.

FIG. 13 is a flowchart depicting embodiments of a method in a communications system including a host computer, a base station and a user equipment, according to embodiments herein.

### DETAILED DESCRIPTION

Embodiments herein may be understood to relate to a mechanism for retransmission for CG-SDT. As a summarized overview, the objective of embodiments herein may be understood to be to allow different types of retransmissions of the initial CG-SDT transmission, either as retransmission or by rebuilding the MAC Protocol Data Unit (PDU), taking into account new data that may have arrived after the first transmission.

In further detail, the objective of embodiments herein may be understood to be to allow for different types of transmissions, or retransmissions when no acknowledgement has been received for the initial CG-SDT transmission. In one option, a HARQ retransmission, in the subsequent CG-SDT occasion, may be performed. In another option, the Transport Block (TB) may contain a MAC PDU that may be rebuilt to contain the same or additional Packet Data Convergence Protocol (PDCP) Radio Link Control (RLC) PDU(s), and where a BSR and/or PHR, if included, may be re-calculated if needed, e.g., in the subsequent CG-SDT occasion, taking both the data to be retransmitted and any new data into account. In case of e.g., an updated BSR, this may replace the previous triggered and built BSR. Whether to do a new HARQ retransmissions or to rebuild the payload for this TB may be given in specification, configured, or left to UE implementation.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

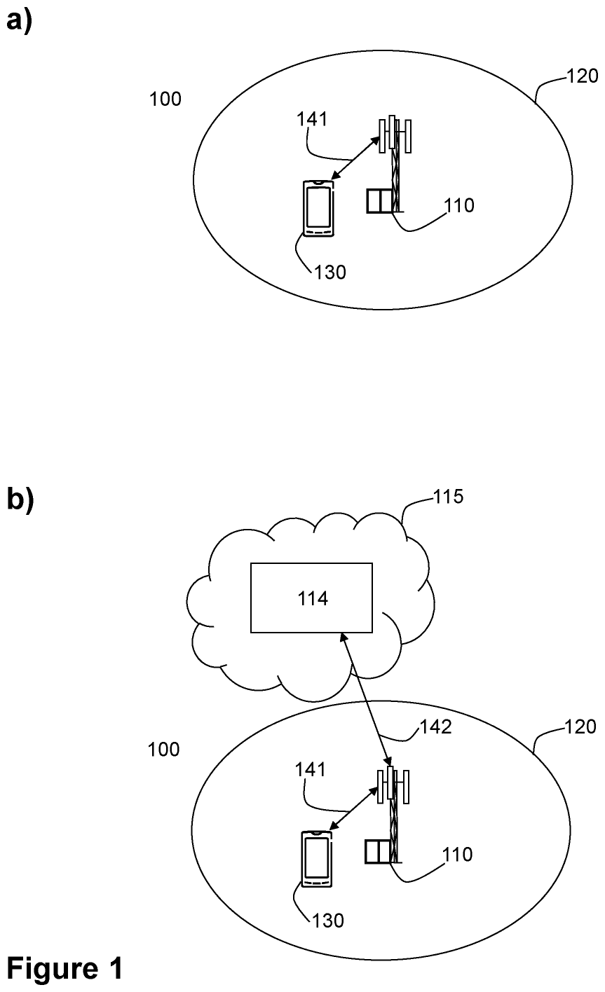

FIG. 1 depicts two non-limiting examples, in panel a) and panel b), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network. In other examples, the wireless communications network 100 may instead, or in addition, support other technologies such as, for example, Long-Term Evolution (LTE), e.g. LTE-M, LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced LAA (eLAA), further enhanced LAA (feLAA) and/or MulteFire. The wireless communications network 100 may support MTC, eMTC, IoT and/or NB-IoT. Yet in other examples, the wireless communications network 100 may support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of network nodes, whereof a network node 110 is depicted in the non-limiting example of FIG. 1. The network node 110 may be a radio network node. That is, a transmission point such as a radio base station, for example a gNB, an eNB, an eNodeB, or a Home Node B, a Home eNode B, or any other network node with similar features capable of serving a user equipment, such as a wireless device or a machine type communication device, in the wireless communications network 100. In some examples, such as that depicted in FIG. 1 b, the network node 110 may be a distributed node, and may partially perform its functions in collaboration with a virtual node 114 in a cloud 115.

The wireless communications network 100 may cover a geographical area, which in some embodiments may be divided into cell areas, wherein each cell area may be served by a radio network node, although, one radio network node may serve one or several cells. In the example of FIG. 1, the network node 110 serves a cell 120. The network node 110 may be of different classes, such as, e.g., macro eNodeB, home eNodeB or pico base station, based on transmission power and thereby also cell size. In some examples, the network node 110 may serve receiving nodes with serving beams. The radio network node may support one or several communication technologies, and its name may depend on the technology and terminology used. Any of the radio network nodes that may be comprised in the communications network 100 may be directly connected to one or more core networks.

A plurality of wireless devices may be located in the wireless communication network 100, whereof a wireless device 130, is depicted in the non-limiting example of FIG. 1. The wireless device 130 comprised in the wireless communications network 100 may be a wireless communication device such as a 5G UE, or a UE, which may also be known as e.g., mobile terminal, wireless terminal and/or mobile station, a mobile telephone, cellular telephone, laptop with wireless capability, a sensor, or an IoT device, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. The wireless device 130 comprised in the wireless communications network 100 may be enabled to communicate wirelessly in the wireless communications network 100. The communication may be performed e.g., via a RAN, and possibly the one or more core networks, which may be comprised within the wireless communications network 100.

The wireless device 130 may be configured to communicate within the wireless communications network 100 with the network node 110 over a first link 141, e.g., a radio link. The network node 110 may be configured to communicate within the wireless communications network 100 with the virtual network node 114 over a second link 142, e.g., a radio link or a wired link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first” and/or “second” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 130, e.g., a 5G UE or a UE, and embodiments related to a network node, such as the network node 110, e.g., a gNB or an eNB.

Some embodiments herein will now be further described with some non-limiting examples.

In the following description, any reference to a/the UE, or simply “UE” may be understood to equally refer the wireless device 130; and any reference to a/the gNB, a/the NW, and/or a/the network, may be understood to equally refer to the network node 110.

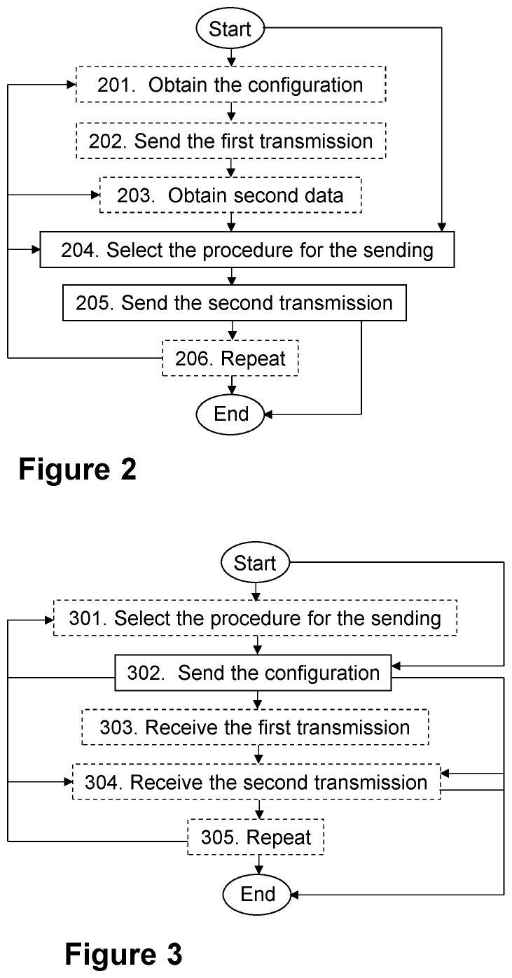

Embodiments of a method, performed by a wireless device, such as the wireless device 130, will now be described with reference to the flowchart depicted in FIG. 2. The method may be understood to be for handling transmission. The wireless device 130 operates in a wireless communications network, such as the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

In some examples, the wireless communications network 100 may be a 5G network.

Several embodiments are comprised herein. In some embodiments, all the actions may be performed. In other embodiments, some of the actions may be performed. It should be noted that the examples herein are not mutually exclusive. Components from one embodiment may be tacitly assumed to be present in another embodiment and it will be obvious to a person skilled in the art how those components may be used in the other exemplary embodiments. For example, in some examples, Action 203 and Action 205 may be performed. One or more embodiments may be combined, where applicable. All possible combinations are not described to simplify the description. A non-limiting example of the method performed by the wireless device 130 is depicted in FIG. 2. In FIG. 2, optional actions are represented with dashed lines. The actions may be performed in a different order than that depicted in FIG. 2.

### Action 201

In this Action 201, the wireless device 130 may obtain a configuration. The obtaining of the configuration may be, e.g., by obtaining an indication.

The configuration may enable the wireless device 130 to, after a first transmission of first data in a first subset of a set of periodic uplink time-frequency resources for uplink communication to the network node 110, wherein a size of a buffer of the wireless device 130 for the uplink transmission of the first data is smaller than a threshold, and, in the absence of having received an acknowledgement from the network node 110 that the first data has been received, select a procedure for sending a second transmission to the network node 110. The procedure may be understood as e.g., a method for retransmission.

That the size of the buffer of the wireless device 130 for the uplink transmission of the first data may be smaller than the threshold may be understood to mean that the first data may be small data. The first data transmission may be a small data transmission, SDT.

The set of periodic uplink time-frequency resources for uplink communication to the network node 110 may be, e.g., a configured grant small data transmission (CG-SDT). For example, CG-SDT resource, CG PUSCH resource, or CG configured PUSCH resource, which, may be understood to mean the time, frequency and/or Demodulation Reference Signal (DMRS) resources configured in a configured grant for PUSCH transmissions.

The first transmission and the second transmission belong to a same HARQ process.

In a particular example, the first transmission may be a first initial CG-SDT transmission, including a RRCResumeRequest message multiplexed with data and possibly a BSR and/or a PHR. Following this example, the configuration may for example specify that the wireless device 130 may have to select the procedure if, at the next CG-SDT resource for the same HARQ process, no acknowledgement of the first initial CG-SDT transmission has been received.

The procedure may be one of the following four options. According to a first option i), the procedure may be a HARQ retransmission. The HARQ retransmission may be with the same or specified RV.

According to a second option ii), the procedure may be an initial transmission comprising a same message to resume communications as a message to resume communications comprised in the first transmission. The message to resume communications may be e.g., an RRCResumeRequest message. In embodiments herein, the first, initial, transmission in the first subset of the set of periodic uplink time-frequency resources for uplink communication to the network node 110, e.g., the first initial CG-SDT transmission, may be taken to be the first transmission which may include a RRCResumerequest.

According to a third option iii), the procedure may be the initial transmission comprising the same message to resume communications and at least one of: a MAC PDU, an updated MAC PDU, an updated report on a status of the buffer of the wireless device 130 with respect to a report on the status of the buffer of the wireless device 130 comprised in the first transmission, and an updated report on the power of the wireless device 130 with respect to a report on the power of the wireless device 130 comprised in the first transmission. As stated above, the message to resume communications may be e.g., an RRCResumeRequest message. A MAC PDU for transmission in a Transport Bloch (TB) may consist of one or several MAC SubPDUs containing higher layer protocol entities, and may contain MAC CEs including padding. The report on the status of the buffer of the wireless device 130 may be, e.g., a BSR. The report on the power of the wireless device 130 may be, e.g., a PHR. In a particular example, according to this third option iii), the procedure may be, e.g., a new first initial CG-SDT transmission containing the same RRCReleaseRequest message and possibly different or updated MAC PDU payload, including possibly an updated BSR and possibly an updated PHR. In embodiments herein, this second option may be called rebuilt retransmission.

According to a fourth option iv), the procedure may be and a random access or random access of small data transmission for transmission of data, e.g., second data. For example, according to the fourth option iv), the procedure may trigger legacy RA or RA-SDT for the transmission of the data.

In some particular embodiments, the configuration may be a first configuration. The first configuration may indicate that the HARQ retransmission or the initial transmission comprising the same message to resume communications is always selected.

The selection of possible options for the retransmissions may be configured in different ways. For example, the configuration may be given in the specification, e.g., 38.321, v. 16.7.0.

In some embodiments, the configuration may be retrieved from a memory.

In some examples, the configuration may be indicated in system information. The signaling may include if selection is allowed and which criteria may be used. The criteria will be explained in Action 204.

In some examples, the configuration may be indicated in the RRCRelease message. In this case, the indication may include if selection is allowed and which criteria that may be used. May be for a specific UE.

In some examples, the configuration may be indicated in the SDT CG RRC configuration.

In some embodiments, the obtaining in this Action 201 may be, e.g., from the network node 110, e.g., via the first link 141, e.g., by one of: System Information, in a message to release communications, e.g., a RRCRelease message, and in a Small Data Configured Grant Radio Resource Control configuration.

The configuration may further specify the

By obtaining the configuration in this Action 201, the wireless device 130 may then be enabled to, after a first transmission of data to the network node 110 may not have been acknowledged, select a method for retransmission, e.g., based on a number of criteria, which will be explained later. As, in contrast to existing methods, the wireless device 130 may not need to wait for an acknowledgement from the network node 110 before the wireless device 103 may be able to retransmit the first transmission or continue with new transmissions of subsequent data, the obtaining of the configuration in this Action 201 may be understood to enable the wireless device 130 to perform efficient retransmissions of the first transmission, e.g., the initial CG-SDT transmission. Embodiments herein may be understood to enhance the performance of CG-SDT by also allowing rebuilding for retransmissions, optionally also including additional data.

### Action 202

In this Action 202, the wireless device 130 may send the first transmission, which may be considered as an initial transmission. The sending of the first transmission in this Action 202 may be understood to be in the first subset of the set of periodic uplink time-frequency resources for uplink communication to the network node 110.

The sending in this Action 202 may be to the network node 110, e.g., via the first link 141.

The first transmission may further comprise at least one of: the message to resume communications, e.g., a RadioResourceControlResumeRequest message, the report on a status of the buffer of the wireless device 130, e.g., a BSR, and the report on a power of the wireless device 130, e.g., a PHR.

By, in this Action 202, sending the first transmission to the network node 110 in the first subset of the set of periodic uplink time-frequency resources for uplink communication to the network node 110, the wireless device 130 may be enabled to transmit data to the network node 110 in inactive state, that is, before the communications with the network node 110 may have been resumed, hence avoiding to incur latency and usage of signalling resources to send data.

### Action 203

In this Action 203, the wireless device 130 may obtain data, e.g., second data. The second data may be understood as new data.

The data, e.g., second data, may be obtained after the first transmission of the first data.

The first transmission may be understood to be by the wireless device 130. The first transmission may be in the first subset of the set of periodic uplink time-frequency resources for uplink communication to the network node 110.

The size of the buffer of the wireless device 130 for the uplink transmission of the first data or the second data may be smaller than the threshold. That is, the first data or the second data may be small data.

Obtaining may be understood as that the second data may arrive for transmission.

### Action 204

In this Action 204, the wireless device 130 may, after the first transmission of the first data in the first subset of the set of periodic uplink time-frequency resources for uplink communication to the network node 110, wherein the size of the buffer of the wireless device 130 for the uplink transmission of the first data is smaller than the threshold, and, in the absence of having received an acknowledgement from the network node 110 that the first data has been received, select the procedure. The procedure is for sending the second transmission to the network node 110. The procedure is one of: i) the HARQ retransmission, ii) the initial transmission comprising the same message to resume communications as the message to resume communications comprised in the first transmission e.g., the same RadioResourceControlResumeRequest message, in other words a new initial transmission, iii) the initial transmission comprising the same message to resume communications, e.g., the same RadioResourceControlResumeRequest message, and at least one of: the MAC PDU, the updated MAC PDU, the updated report on the status of the buffer of the wireless device 130, e.g., BSR, with respect to the report on the status of the buffer of the wireless device 130 comprised in the first transmission, and the updated report on the power of the wireless device 130, e.g., PHR, with respect to the report on the power of the wireless device 130 comprised in the first transmission, and iv) the random access or random access of small data transmission for the transmission of the data, e.g., first data and/or second data.

In one aspect of embodiments herein, only the BSR may be updated. This may be in the case when a BSR may have been included in the initial transmission but the transmission has not been acknowledged. In this case, the RRC message, the RRCResumeRequest, and the data payload in the MAC PDU may be the same as in the first, initial, transmission, but the BSR may be updated to indicate a different buffer status.

In one aspect of embodiments herein, only the PHR may be updated. This may be in the case when a PHR may have been included in the initial transmission, but the transmission has not been acknowledged. In this case, the RRC message, the RRCResumeRequest, and the data payload in the MAC PDU may be the same as in the first, initial, transmission, but the PHR may be updated to indicate a different power headroom.

In one aspect of embodiments herein, only the BSR and the PHR may be updated. This may be in the case when a BSR and a PHR may have been included in the initial transmission, but the transmission has not been acknowledged. In this case, the RRC message, the RRCResumeRequest, and the data payload in the MAC PDU may be the same as in the first, initial, transmission but the BSR may be updated to indicate a different buffer status and the PHR may be updated to indicate a different power headroom.

In one aspect of embodiments herein, the first, initial, transmission may have contained only RRCResumeRequest message and data payload. In this case, when the first, initial, transmission has not been acknowledged, the retransmission may be rebuilt to include the RRC message, the RRCResumeRequest, and updated data payload. In another example, the retransmission may be rebuilt to include the RRC message, the RRCResumeRequest, and updated data payload and a BSR and PHR.

In case only the BSR may be updated when rebuilding the MAC PDU, the choice of HARQ retransmission or rebuilding may be made by the wireless device 130. In one example, this may be captured in Section 5.4.5 of 3GPP TS 38.321 as, the underlined text indicated below, which may be understood to be an addition to the existing specification:
NOTE 5: If a HARQ process is configured with cg-Retransmission Timer or cg-SDT-Retransmission Timer and if the BSR is already included in a MAC PDU for transmission by this HARQ process, but not yet transmitted by lower layers, or in the case of SDT, an initial transmission has not yet been acknowledged, it is up to UE implementation how to handle the BSR content.

The selecting in this Action 204 may be based on at least one of the following criteria. As stated earlier, these criteria may be included in the configuration obtained in Action 201. The selection may be configured or specified to depend on one, or a combination of the following conditions.

According to a first criterion, the selecting in this Action 204 may be based on whether or not a configured timer, e.g., a configured grant small data transmission RetransmissionTimer, cg-SDT-RetransmissionTimer, is configured and running.

According to a second criterion, the selecting in this Action 204 may be based on a periodicity of the set of periodic uplink time-frequency resources for uplink communication to the network node 110 of data, wherein the size of the buffer of the wireless device 130 for the uplink transmission of the data is smaller than the threshold. This may be the periodicity of the CG-SDT resources. For example, if the periodicity or time to next CG-SDT resource for the same HARQ process is larger than a threshold, the rebuilt retransmission may be chosen.

According to a third criterion, the selecting in this Action 204 may be based on whether or not the second data is obtained before a subsequent subset of the set of periodic uplink time-frequency resources for uplink communication to the network node 110 of the data for the same HARQ process. For example, if new data arrives before the next CG-SDT resource for the same HARQ process.

According to a fourth criterion, the selecting in this Action 204 may be based on whether or not the second data is obtained resulting in a different Buffer Size for the report on the status of the buffer of the wireless device 130, e.g., BSR, before the next subset of periodic uplink time-frequency resources for uplink communication to the network node 110 of the data for the same HARQ process. For example, if new data arrives resulting in a different Buffer Size for the BSR before the next CG-SDT resource for the same HARQ process.

According to a fifth criterion, the selecting in this Action 204 may be based on a priority of the second data. For example, if new data arrives with a higher priority, e.g., new data mapped to a Logical channel (LCH) with higher priority.

According to a sixth criterion, the selecting in this Action 204 may be based on whether or not the power headroom changes before the next subset of periodic uplink time-frequency resources for uplink communication to the network node 110 of the data for the same HARQ process. For example, if the power headroom changes before the next CG-SDT resource for the same HARQ process.

According to a seventh criterion, the selecting in this Action 204 may be based on a configuration indicating that the HARQ retransmission or the initial transmission comprising the same message to resume communications, e.g., the same RadioResourceControlResumeRequest message, is always selected. For example, the first or second method, HARQ retransmission or rebuilding, may always be selected.

In some embodiments, the selecting in this Action 204 of the procedure may be performed after obtaining the second data. The selecting of the procedure may be for the sending in Action 205 of the second data in the second transmission.

In some embodiments, the selecting in this Action 204 may be performed one of: a) autonomously by the wireless device 130, b) based on the configuration retrieved from the memory, and c) based on the configuration, received from the network node 110. In one aspect of embodiments herein, the decision of which method to use may be determined by the UE. The decision may depend on the same conditions as above.

In some embodiments, with the proviso that only the report on the status of the buffer of the wireless device 130, e.g., the BSR, may be able to be updated for the initial transmission comprising the MAC PDU, the selecting in this Action 204 may be performed autonomously by the wireless device 130.

By, in the absence of having received an acknowledgement from the network node 110 that the first data has been received, selecting the procedure for sending the second transmission to the network node 110, e.g., according to the one or more criteria, in this Action 204, the wireless device 130 may be enabled to, in contrast to existing methods, not need to wait for an acknowledgement from the network node 110 before being able to retransmit the first transmission or continue with new transmissions of subsequent data. By selecting the procedure, e.g., according to the one or more criteria, the wireless device 130 may be then enabled to perform efficient retransmissions of the first transmission, e.g., the initial CG-SDT transmission, and to do in a manner that may be most optimal, given the circumstances that may apply at any given moment, e.g., based on for example, if additional, second data, may have arrived, and/or based on the priority this new, second data. Embodiments herein may be understood to enhance the performance of CG-SDT by also allowing rebuilding for retransmissions, optionally also including the additional data.

### Action 205

In this Action 205, the wireless device 130 sends the second transmission to the network node 110. The sending in this Action 205 may be, e.g., via the first link 141. The sending of the second transmission in this Action 205 may be understood to be according to the selected method in Action 204.

The sending in this Action 205 of the second transmission is in a second subset of the set of periodic uplink time-frequency resources. The second subset is a next subset of the first subset, that is, next in the time dimension.

The sending in this Action 205 is in the absence of having received an acknowledgement from the network node 110 that the first data has been received.

In some examples, the second transmission may comprise the second data and a retransmission of the first data. The first transmission and the second transmission may belong to the same HARQ process.

By the wireless device 130, in this Action 205, sending the second transmission to the network node 110 in the next subset of the first subset, using the selected procedure, the wireless device may perform efficient retransmissions of the first transmission, e.g., the initial CG-SDT transmission, and to do in a manner that may be most optimal, given the circumstances that may apply at any given moment.

### Action 206

The wireless device 130 may repeat any or all of the obtaining of Action 203, the selecting of Action 204 and the sending of Action 205 for third data.

In some examples, the repeating may comprise repeating Action 201, Action 204, e.g., for third data, and Action 205, and optionally, also Action 203. In some examples, the repeating may comprise repeating Action 203 and Action 205.

In this Action 206, the wireless device 130 may repeat the obtaining from Action 203, the selecting from Action 204 and the sending from Action 205 for third data. The selected procedure for transmission of the third data may be one of: the same or different than that selected for the second transmission.

In some examples, the size of the buffer of the wireless device 130 for the uplink transmission of the third data may be smaller than the threshold. In such examples, the third data may be understood to be small data.

The selected procedure for transmission of the third data may be one of: the same or different than that selected for the second transmission of the second data. In one option of embodiments herein, the method may use different retransmission types. For example, the first and second retransmission may be a HARQ retransmission, and the third retransmission may use rebuilding.

Embodiments of a method, performed by a network node, such as the network node 110, will now be described with reference to the flowchart depicted in FIG. 3. The method may be understood to be for handling transmission. The network node 110 operates in a wireless communications network, such as the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

In some embodiments, the wireless communications network 100 may be a 5G network.

Several embodiments are comprised herein. In some embodiments, all the actions may be performed. In other embodiments, some of the actions may be performed. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. A non-limiting example of the method performed by the network node 110 is depicted in FIG. 3. In FIG. 3, optional actions are represented with dashed lines.

The detailed description of some of the following corresponds to the same references provided above, in relation to the actions described for the wireless device 130 and will thus not be repeated here to simplify the description. For example, the set of periodic uplink time-frequency resources for uplink communication to the network node 110 may be, e.g., a configured grant small data transmission. For example, any of the first data, the second data and the third data may be small data.

The actions may be performed in a different order than that depicted in FIG. 3. For example, Action 301 and Action 302 may be performed after Action 303 and before Action 304.

### Action 301

In this Action 301, the network node 110 may select the procedure. The selecting of the procedure may be for the sending, by the wireless device 130, of the second transmission. For example, the second data in the second transmission.

The procedure is for, after a the first transmission by the wireless device 130 of the first data in the first subset of the set of periodic uplink time-frequency resources for uplink communication to the network node 110, wherein the size of the buffer of the wireless device 130 for the uplink transmission of the first data is smaller than the threshold, and, in the absence of having received an acknowledgement from the network node 110 that the first data has been received, sending the second transmission to the network node 110.

The procedure may be one of: i) the HARQ retransmission, ii) the initial transmission comprising the same message to resume communications, e.g., the same RadioResourceControlResumeRequest message, iii) the initial transmission comprising the same message to resume communications, e.g., the same RadioResourceControlResumeRequest message, and the at least one of: the MAC PDU, the updated MAC PDU, the updated report on the status of the buffer of the wireless device 130, e.g., the BSR, and the updated report on the power of the wireless device 130, e.g., the PHR, and iv) the random access or random access of small data transmission for the transmission of the data.

The selecting by the network node 110 in this Action 301 may be based on at least one of: a) whether or not the configured timer, e.g., the configured grant small data transmission RetransmissionTimer, cg-SDT-RetransmissionTimer, may be configured and running, b) the periodicity of the set of periodic uplink time-frequency resources for uplink communication to the network node 110 of data, wherein the size of the buffer of the wireless device 130 for the uplink transmission of the data is smaller than the threshold, c) whether or not the second data is obtained by the wireless device 130 before the subsequent subset of the set of periodic uplink time-frequency resources for uplink communication to the network node 110 of the data for the same HARQ process, d) whether or not the second data is obtained resulting in a different Buffer Size for the report on the status of the buffer of the wireless device 130, e.g., BSR, before the next subset of periodic uplink time-frequency resources for uplink communication to the network node 110 of the data for the same HARQ process, e) the priority of the second data, f) whether or not the power headroom changes before the next subset of periodic uplink time-frequency resources for uplink communication to the network node 110 of the data for the same HARQ process, and g) the first configuration indicating that the HARQ retransmission or the initial transmission comprising the same message to resume communications, e.g., the same RadioResourceControlResumeRequest message, is always selected.

### Action 302

In this Action 302, the network node 110 sends the configuration to the wireless device 130. The wireless device 130 is to perform the selection based on the configuration. The selection is of the procedure. The procedure is for, after the first transmission by the wireless device 130 of first data in the first subset of the set of periodic uplink time-frequency resources for uplink communication to the network node 110, wherein the size of the buffer of the wireless device 130 for the uplink transmission of the first data is smaller than the threshold, and, in the absence of having received an acknowledgement from the network node 110 that the first data has been received, sending the second transmission to the network node 110.

The procedure is one of: i) the HARQ retransmission, ii) the initial transmission comprising the same message to resume communications as the message to resume communications comprised in the first transmission, iii) the initial transmission comprising the same message to resume communications and at least one of: the MAC PDU, the updated MAC PDU, the updated report on the status of the buffer of the wireless device 130 with respect to the report on the status of the buffer of the wireless device 130 comprised in the first transmission, and the updated report on the power of the wireless device 130 with respect to the report on the power of the wireless device 130 comprised in the first transmission, and iv) the random access or random access of small data transmission for the transmission of the data.

The sending in this Action 302 may be performed, e.g., via the first link 141.

The sending of the configuration may be, e.g., by sending an indication.

The signaling may include if selection is allowed and which criteria may be used. In other words, in this Action 302, the network node 110 may configure the wireless device 130 with the procedure it may need to select, as the network node 110 may have selected in Action 301, or configure the wireless device 130 on how to perform the selection, that is, based on which criteria, as follows.

The selecting may be to be based on at least one of: a) whether or not the configured timer is configured and running, b) the periodicity of the set of periodic uplink time-frequency resources for uplink communication to the network node 110 of data, wherein the size of the buffer of the wireless device 130 for the uplink transmission of the data is smaller than the threshold, c) whether or not second data is obtained by the wireless device 130 before the subsequent subset of the set of periodic uplink time-frequency resources for uplink communication to the network node 110 of the data for the same HARQ process, d) whether or not the second data is obtained by the wireless device 130 resulting in a different Buffer Size for the report on the status of the buffer of the wireless device 130 before the next subset of periodic uplink time-frequency resources for uplink communication to the network node 110 of the data for the same HARQ process, e) the priority of the second data, f) whether or not the power headroom changes before the next subset of periodic uplink time-frequency resources for uplink communication to the network node 110 of the data for the same HARQ process, and g) the first configuration, the first configuration indicating that the HARQ retransmission or the initial transmission comprising the same message to resume communications is always selected.

The sending in this Action 302 of the configuration may be e.g., by one of: System Information, in the message to release communications, e.g., the RRCRelease message, and in the Small Data Configured Grant Radio Resource Control configuration.

In some examples, the configuration may be indicated in the RRCRelease message. In this case, the indication may include if selection is allowed and which criteria that may be used. May be for a specific UE.

In some examples, the configuration may be indicated in the SDT CG RRC configuration.

By the network node 110 sending the configuration to the wireless device 130, wherein the wireless device 130 is to perform a selection based on the configuration, the network node 110 may enable the wireless device 130 to, after the first transmission of data to the network node 110 may not have been acknowledged, select the method for retransmission. As, in contrast to existing methods, the wireless device 130 may not need to wait for an acknowledgement from the network node 110 before the wireless device 103 may be able to retransmit the first transmission or continue with new transmissions of subsequent data, the sending of the configuration in this Action 302 may be understood to enable the wireless device 130 to perform efficient retransmissions of the first transmission, e.g., the initial CG-SDT transmission. Embodiments herein may be understood to enhance the performance of CG-SDT by also allowing rebuilding for retransmissions, optionally also including additional data, such as the second data and/or the third data.

### Action 303

In some embodiments, in this Action 303, the network node 110 may receive the first transmission from the wireless device 130.

The receiving in this Action 305 may be, e.g., via the first link 141.

The first transmission may further comprise at least one of: i) the message to resume communications, e.g., the RadioResourceControlResumeRequest message, ii) the report on the status of the buffer of the wireless device 130, e.g., the BSR, and iii) the report on the power of the wireless device 130, e.g., the PHR.

### Action 304

In this Action 304, the network node 110 may receive the second transmission from the wireless device 130. The receiving in this Action 304 of the second transmission may be in the second subset of the set of periodic uplink time-frequency resources. The second subset may be the next subset of the first subset of the set of periodic uplink time-frequency resources for uplink communication to the network node 110, that is, next in the time dimension. It may be understood that the second transmission may be received according to the procedure, as selected by the wireless device 130, and in some examples, according to the selection performed by the network node 110 in Action 301.

The size of the buffer of the wireless device 130 for the uplink transmission of the first data or the second data may be smaller than the threshold. That is, the first data or the second data may be small data. The first data transmission may be an SDT.

The first data may have been previously transmitted by the wireless device 130 in the first transmission in the first subset of the set of periodic uplink time-frequency resources for uplink communication to the network node 110.

The first transmission and the second transmission may belong to the same HARQ process.

The second transmission may comprise the second data and the retransmission of the first data.

The receiving of the second transmission in this Action 304 may be, e.g., via the first link 141.

In some embodiments, with the proviso that only the report on the status of the buffer of the wireless device 130, e.g., the BSR, may be able to be updated for the initial transmission comprising the MAC PDU, the receiving in this Action 304 of the second transmission may be performed based on the procedure as selected autonomously by the wireless device 130.

The receiving in this Action 304 of the second transmission may be in the absence of one of: a) the network node 110 having sent the acknowledgement to the wireless device 130 that the first data has been received, and b) the wireless device 130 having received the acknowledgement from the network node 110 that the first data has been received.

### Action 305

The network node 110 may repeat any or all of the selecting of Action 301, the sending of Action 302 and the receiving of Action 304, e.g., for the third data. In some examples, the repeating may comprise repeating Action 304, and optionally, also Action 301 and Action 302.

In this Action 305, the network node 110 may repeat the selecting of Action 301, the sending of Action 302 and the receiving of Action 304 for the third data. The size of the buffer of the wireless device 130 for the uplink transmission of the third data may be smaller than the threshold. The third data may be understood to be small data. The selected procedure for transmission of the third data may be one of: the same or different than that selected for the second transmission of the second data.

The receiving, in this Action 304, of the second transmission may be performed based on the procedure selected by the network node 110 and provided to the wireless device 130, e.g., in the configuration sent from the network node 110.

Certain embodiments disclosed herein may provide one or more of the following technical advantage(s), which may be summarized as follows. Embodiments herein, may be understood to enable efficient retransmissions of the initial CG-SDT transmission. The embodiments herein may be understood to enhance the performance of CG-SDT by also allowing rebuilding for retransmissions.

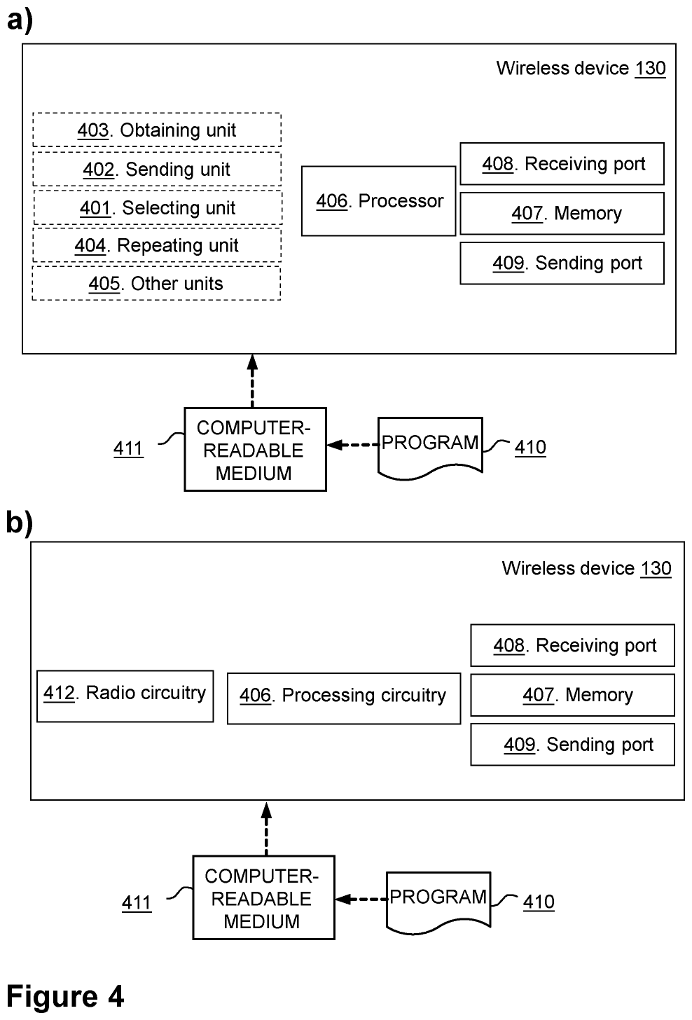

FIG. 4 depicts two different examples in panels a) and b), respectively, of the arrangement that the wireless device 130 may comprise to perform the method actions described above in relation to FIG. 2. In some embodiments, the wireless device 130 may comprise the following arrangement depicted in FIG. 4a. The wireless device 130 may be understood to be for handling transmission. The wireless device 130 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130, and will thus not be repeated here. For example, any of the first data, the second data and the third data may be small data.

In FIG. 4, optional modules are indicated with dashed boxes.

The wireless device 130 is configured to perform the selecting of Action 204, e.g. by means of a selecting unit 401 within the wireless device 130, configured to after the first transmission of the first data in the first subset of the set of periodic uplink time-frequency resources for uplink communication to the network node 110, wherein the size of the buffer of the wireless device 130 for the uplink transmission of the first data is configured to be smaller than the threshold, and, in the absence of having received an acknowledgement from the network node 110 that the first data has been received, select the procedure for sending the second transmission to the network node 110. The procedure is configured to be one of: i) is the HARQ retransmission, ii) the initial transmission configured to comprise the same message to resume communications as the message to resume communications configured to be comprised in the first transmission, iii) the initial transmission configured to comprise the same message to resume communications and at least one of: the MAC PDU, the updated MAC PDU, the updated report on the status of the buffer of the wireless device with respect to the report on the status of the buffer of the wireless device 130 configured to be comprised in the first transmission, and the updated report on the power of the wireless device 130 with respect to the report on the power of the wireless device 130 configured to be comprised in the first transmission, and iv) the random access or random access of small data transmission for the transmission of the data.

The wireless device 130 may be configured to perform the sending of Action 205, e.g., by means of a sending unit 402 within the wireless device 130, configured to send the second transmission to the network node 110. The sending of the second transmission is configured to be in the second subset of the set of periodic uplink time-frequency resources. The second subset is configured to be the next subset of the first subset.

In some embodiments, the selecting may be configured to be based on at least one of the following: a) whether or not the configured timer is configured and running, b) the periodicity of the set of periodic uplink time-frequency resources for uplink communication to the network node 110 of data, wherein the size of the buffer of the wireless device 130 for the uplink transmission of the data is smaller than the threshold, c) whether or not the second data is obtained before the subsequent subset of the set of periodic uplink time-frequency resources for uplink communication to the network node 110 of the data for the same HARQ process, d) whether or not the second data is obtained resulting in a different Buffer Size for the report on the status of the buffer of the wireless device 130 before the next subset of periodic uplink time-frequency resources for uplink communication to the network node 110 of the data for the same HARQ process, e) the priority of the second data, f) whether or not the power headroom changes before the next subset of periodic uplink time-frequency resources for uplink communication to the network node 110 of the data for the same HARQ process, and g) the first configuration. The first configuration may indicate that the HARQ retransmission or the initial transmission comprising the same message to resume communications is always selected.

In some embodiments, the first transmission and the second transmission may be configured to belong to the same HARQ process.

The wireless device 130 may be configured to perform the sending of Action 202, e.g. by means of the sending unit 402 within the wireless device 130, configured to send the first transmission. The first transmission may be configured to further comprise at least one of: the message to resume communications, the report on the status of the buffer of the wireless device 130, and the report on the power of the wireless device 130.

The wireless device 130 may be configured to perform the obtaining of Action 203, e.g. by means of an obtaining unit 403 within the wireless device 130, configured to obtain the second data. The selecting the procedure may be configured to be performed after obtaining the second data.

In some embodiments, the wireless device 130 may be configured to send the first transmission and obtain the second data as just described.

The wireless device 130 may be configured to perform the repeating of Action 206, e.g. by means of a repeating unit 404 within the wireless device 130, configured to repeat the obtaining, the selecting and the sending for third data. The procedure for transmission of the third data configured to be selected may be configured to be one of: the same or different than that configured to be selected for the second transmission.

In some embodiments, the selecting may be configured to be performed one of: a) autonomously by the wireless device 130, b) based on the configuration, retrieved from the memory, and c) based on the configuration, configured to be received from the network node 110.

The wireless device 130 may be configured to perform the obtaining of Action 201, e.g. by means of the obtaining unit 403 within the wireless device 130, configured to obtain the configuration.

In some embodiments, with the proviso that only the report on the status of the buffer of the wireless device 130 is able to be updated for the initial transmission comprising the MAC PDU, the selecting may be configured to be performed autonomously by the wireless device 130.

Other units 405 may be comprised in the wireless device 130.

The embodiments herein in the wireless device 130 may be implemented through one or more processors, such as a processor 406 in the wireless device 130 depicted in FIG. 4a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The wireless device 130 may further comprise a memory 407 comprising one or more memory units. The memory 407 is arranged to be used to store obtained information, store data, configurations, schedulings, and applications etc. to perform the methods herein when being executed in the wireless device 130.

In some embodiments, the wireless device 130 may receive information from, e.g., the network node 110 or another network node or device through a receiving port 408. In some embodiments, the receiving port 408 may be, for example, connected to one or more antennas in wireless device 130. In other embodiments, the wireless device 130 may receive information from another structure in the wireless communications network 100 through the receiving port 408. Since the receiving port 408 may be in communication with the processor 406, the receiving port 408 may then send the received information to the processor 406. The receiving port 408 may also be configured to receive other information.

The processor 406 in the wireless device 130 may be further configured to transmit or send information to e.g., the network node 110, another network node or device, or another structure in the wireless communications network 100, through a sending port 409, which may be in communication with the processor 406, and the memory 407.

Those skilled in the art will also appreciate that the different units 401-405 described above may refer to a combination of analog and digital modules, and/or one or more processors configured with software and/or firmware, e.g., stored in memory, that, when executed by the one or more processors such as the processor 406, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 401-405 described above may be implemented as one or more applications running on one or more processors such as the processor 406.

Thus, the methods according to the embodiments described herein for the wireless device 130 may be respectively implemented by means of a computer program 410 product, comprising instructions, i.e., software code portions, which, when executed on at least one processor 406, cause the at least one processor 406 to carry out the actions described herein, as performed by the wireless device 130. The computer program 410 product may be stored on a computer-readable storage medium 411. The computer-readable storage medium 411, having stored thereon the computer program 410, may comprise instructions which, when executed on at least one processor 406, cause the at least one processor 406 to carry out the actions described herein, as performed by the wireless device 130. In some embodiments, the computer-readable storage medium 411 may be a non-transitory computer-readable storage medium, such as a CD ROM disc, or a memory stick. In other embodiments, the computer program 410 product may be stored on a carrier containing the computer program 410 just described, wherein the carrier is one of an electronic signal, optical signal, radio signal, or the computer-readable storage medium 411, as described above.

The wireless device 130 may comprise a communication interface configured to facilitate communications between the wireless device 130 and other nodes or devices, e.g., the network node 110, another network node or device, or another structure in the wireless communications network 100. The interface may, for example, include a transceiver configured to transmit and receive radio signals over an air interface in accordance with a suitable standard.

In other embodiments, the wireless device 130 may comprise the following arrangement depicted in FIG. 4b. The wireless device 130 may comprise a processing circuitry 406, e.g., one or more processors such as the processor 406, in the wireless device 130 and the memory 407. The wireless device 130 may also comprise a radio circuitry 412, which may comprise e.g., the receiving port 408 and the sending port 409. The processing circuitry 412 may be configured to, or operable to, perform the method actions according to FIG. 2, in a similar manner as that described in relation to FIG. 4a. The radio circuitry 412 may be configured to set up and maintain at least a wireless connection with the network node 110, another network node or device, or another structure in the wireless communications network 100. Circuitry may be understood herein as a hardware component.

Hence, embodiments herein also relate to the wireless device 130 comprising the processing circuitry 406 and the memory 407, said memory 407 containing instructions executable by said processing circuitry 406, whereby the wireless device 130 is operative to perform the actions described herein in relation to the wireless device 130, e.g., in FIG. 2.

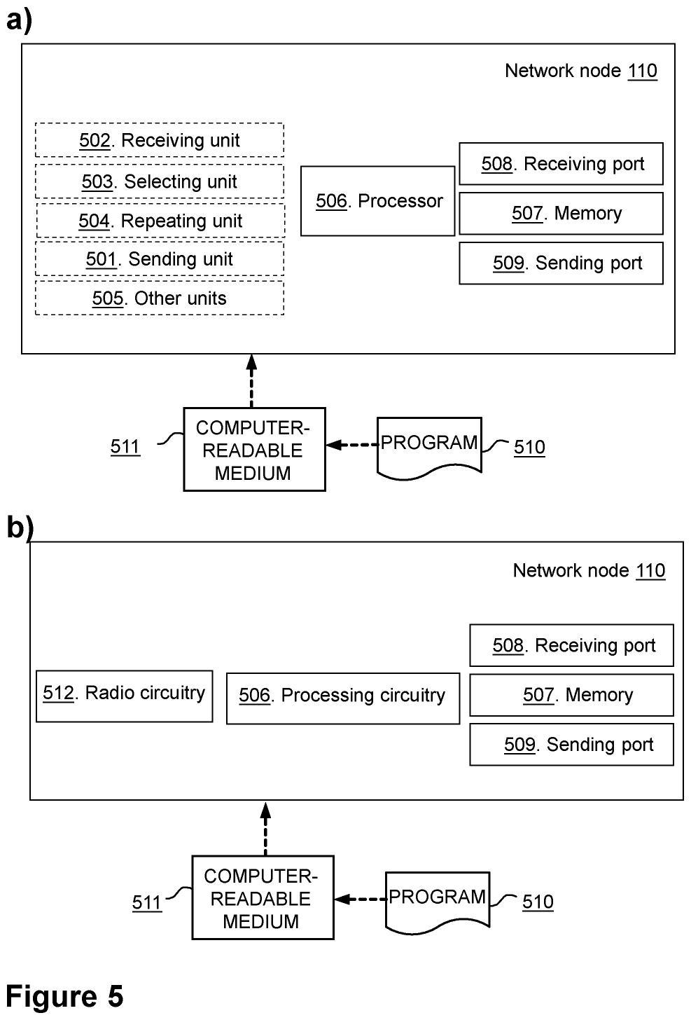

FIG. 5 depicts two different examples in panels a) and b), respectively, of the arrangement that the network node 110 may comprise to perform the method actions described above in relation to FIG. 3. In some embodiments, the network node 110 may comprise the following arrangement depicted in FIG. 5a. The network node 110 may be understood to be for handling transmission. The network node 110 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130, and will thus not be repeated here. For example, any of the first data, the second data and the third data may be small data.

In FIG. 5, optional units are indicated with dashed boxes.

The network node 110 is configured to perform the sending of Action 302, e.g., by means of a sending unit 501 within the network node 110, configured to send the configuration to the wireless device 130. The wireless device 130 is to perform the selection based on the configuration. The selection is configured to be of the procedure for, after the first transmission by the wireless device 130 of the first data in the first subset of the set of periodic uplink time-frequency resources for uplink communication to the network node 110, wherein the size of the buffer of the wireless device 130 for the uplink transmission of the first data is configured to be smaller than the threshold, and, in the absence of having received an acknowledgement from the network node 110 that the first data has been received, sending the second transmission to the network node 110. The procedure is configured to be one of: i) the HARQ retransmission, ii) the initial transmission configured to comprise the same message to resume communications as the message to resume communications configured to be comprised in the first transmission, iii) the initial transmission configured to comprise the same message to resume communications and at least one of: the MAC PDU, the updated MAC PDU, the updated report on the status of the buffer of the wireless device 130 with respect to the report on the status of the buffer of the wireless device 130 configured to be comprised in the first transmission, and the updated report on the power of the wireless device 130 with respect to the report on the power of the wireless device 130 configured to be comprised in the first transmission, and iv) the random access or random access of small data transmission for the transmission of the data.

In some embodiments, the selecting by the wireless device 130 may be to be configured to be based on at least one of the following: a) whether or not the configured timer is configured and running, b) the periodicity of the set of periodic uplink time-frequency resources for uplink communication to the network node 110 of data, wherein the size of the buffer of the wireless device 130 for the uplink transmission of the data is smaller than the threshold, c) whether or not the second data is obtained by the wireless device 130 before the subsequent subset of the set of periodic uplink time-frequency resources for uplink communication to the network node 110 of the data for the same HARQ process, d) whether or not the second data is obtained by the wireless device 130 resulting in a different Buffer Size for the report on the status of the buffer of the wireless device 130 before the next subset of periodic uplink time-frequency resources for uplink communication to the network node 110 of the data for the same HARQ process, e) the priority of the second data, f) whether or not the power headroom changes before the next subset of periodic uplink time-frequency resources for uplink communication to the network node 110 of the data for the same HARQ process, and g) the first configuration. The first configuration may indicate that the HARQ retransmission or the initial transmission comprising the same message to resume communications is always selected.

The network node 110 may be configured to perform the receiving of Action 304, e.g., by means of a receiving unit 502 within the network node 110, configured to receive the second transmission from the wireless device 130. The receiving of the second transmission may be configured to be in the second subset of the set of periodic uplink time-frequency resources. The second subset may be configured to be the next subset of the first subset of the set of periodic uplink time-frequency resources for uplink communication to the network node 110.

In some embodiments, at least one of one of the following options may apply. According to a first option, the first data may be configured to have been previously transmitted by the wireless device 130 in the first transmission in the first subset of the set of periodic uplink time-frequency resources for uplink communication to the network node 110, and the first transmission and the second transmission may belong to the same HARQ process. According to a second option, the second transmission may comprise the second data and the retransmission of the first data.

The network node 110 may be configured to perform the receiving of Action 303, e.g. by means of the receiving unit 502 within the network node 110, configured to receive the first transmission from the wireless device 130. The first transmission may be further configured to comprise at least one of: the message to resume communications, the report on the status of the buffer of the wireless device 130, and the report on the power of the wireless device 130. The receiving of the second transmission may be configured to be in the absence of one of: a) the network node 110 having sent the acknowledgement to the wireless device 130 that the first data has been received, and b) the wireless device 130 having received the acknowledgement from the network node 110 that the first data has been received.

The network node 110 may be configured to perform the selecting of Action 301, e.g. by means of a selecting unit 503 within the network node 110, configured to select the procedure for the sending, by the wireless device 130, of the second transmission. The procedure is configured to be one of: i) the HARQ retransmission, ii) the initial transmission comprising the same message to resume communications, iii) the initial transmission comprising the same message to resume communications, and at least one of: the MAC PDU, the updated MAC PDU, the updated report on the status of the buffer of the wireless device 130, and the updated report on the power of the wireless device 130, and iv) the random access or random access of small data transmission for the transmission of the data.

In some embodiments, the selecting by the network node 110 may be configured to be based on at least one of the following: a) whether or not the configured timer is configured and running, b) the periodicity of the set of periodic uplink time-frequency resources for uplink communication to the network node 110 of data, wherein the size of the buffer of the wireless device 130 for the uplink transmission of the data is smaller than the threshold, c) whether or not the second data is obtained by the wireless device 130 before the subsequent subset of the set of periodic uplink time-frequency resources for uplink communication to the network node 110 of the data for the same HARQ process, d) whether or not the second data is obtained resulting in a different Buffer Size for the report on the status of the buffer of the wireless device 130, before the next subset of periodic uplink time-frequency resources for uplink communication to the network node 110 of the data for the same HARQ process, e) the priority of the second data, f) whether or not the power headroom changes before the next subset of periodic uplink time-frequency resources for uplink communication to the network node 110 of the data for the same HARQ process, and g) the first configuration. The first configuration may indicate that the HARQ retransmission or the initial transmission comprising the same message to resume communications is always selected.

The network node 110 may be configured to perform the repeating of Action 305, e.g. by means of a repeating unit 504 within the network node 110, configured to repeat the selecting, the sending and the receiving for the third data, wherein the size of the buffer of the wireless device 130 for the uplink transmission of the third data may be configured to be smaller than the threshold. The selected procedure for transmission of the third data may be configured to be one of: the same or different than that configured to be selected for the second transmission of the second data.

In some embodiments, the receiving of the second transmission may be configured to be performed based on the procedure configured to be selected by the network node 110 and configured to be provided to the wireless device 130.

In some embodiments, with the proviso that only the report on the status of the buffer of the wireless device 130 may be able to be updated for the initial transmission comprising the MAC PDU, the receiving of the second transmission may be performed based on the procedure as selected autonomously by the wireless device 130.

Other units 505 may be comprised in the network node 110.

The embodiments herein in the network node 110 may be implemented through one or more processors, such as a processor 506 in the network node 110 depicted in FIG. 5a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 507 comprising one or more memory units. The memory 507 is arranged to be used to store obtained information, store data, configurations, schedulings, and applications etc. to perform the methods herein when being executed in the network node 110.

In some embodiments, the network node 110 may receive information from, e.g., the wireless device 130, or another node or device through a receiving port 508. In some embodiments, the receiving port 508 may be, for example, connected to one or more antennas in network node 110. In other embodiments, the network node 110 may receive information from another structure in the wireless communications network 100 through the receiving port 508. Since the receiving port 508 may be in communication with the processor 506, the receiving port 508 may then send the received information to the processor 506. The receiving port 508 may also be configured to receive other information.

The processor 506 in the network node 110 may be further configured to transmit or send information to e.g., the wireless device 130, another node or device, or another structure in the wireless communications network 100, through a sending port 509, which may be in communication with the processor 506, and the memory 507.

Those skilled in the art will also appreciate that the different units 501-505 described above may refer to a combination of analog and digital modules, and/or one or more processors configured with software and/or firmware, e.g., stored in memory, that, when executed by the one or more processors such as the processor 506, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 501-505 described above may be implemented as one or more applications running on one or more processors such as the processor 506.

Thus, the methods according to the embodiments described herein for the network node 110 may be respectively implemented by means of a computer program 510 product, comprising instructions, i.e., software code portions, which, when executed on at least one processor 506, cause the at least one processor 506 to carry out the actions described herein, as performed by the network node 110. The computer program 510 product may be stored on a computer-readable storage medium 511. The computer-readable storage medium 511, having stored thereon the computer program 510, may comprise instructions which, when executed on at least one processor 506, cause the at least one processor 506 to carry out the actions described herein, as performed by the network node 110. In some embodiments, the computer-readable storage medium 511 may be a non-transitory computer-readable storage medium, such as a CD ROM disc, or a memory stick. In other embodiments, the computer program 510 product may be stored on a carrier containing the computer program 510 just described, wherein the carrier is one of an electronic signal, optical signal, radio signal, or the computer-readable storage medium 511, as described above.

The network node 110 may comprise a communication interface configured to facilitate communications between the network node 110 and other nodes or devices, e.g., the wireless device 130, another node or device, or another structure in the wireless communications network 100. The interface may, for example, include a transceiver configured to transmit and receive radio signals over an air interface in accordance with a suitable standard.

In other embodiments, the network node 110 may comprise the following arrangement depicted in FIG. 5b. The network node 110 may comprise a processing circuitry 506, e.g., one or more processors such as the processor 506, in the network node 110 and the memory 507. The network node 110 may also comprise a radio circuitry 512, which may comprise e.g., the receiving port 508 and the sending port 509. The processing circuitry 506 may be configured to, or operable to, perform the method actions according to FIG. 3, in a similar manner as that described in relation to FIG. 5a. The radio circuitry 512 may be configured to set up and maintain at least a wireless connection with the wireless device 130, another node or device, or another structure in the wireless communications network 100. Circuitry may be understood herein as a hardware component.

Hence, embodiments herein also relate to the network node 110 comprising the processing circuitry 506 and the memory 507, said memory 507 containing instructions executable by said processing circuitry 506, whereby the network node 110 is operative to perform the actions described herein in relation to the network node 110, e.g., in FIG. 3.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Particular Example of Embodiments Herein

In a first step, according to Action 202, the wireless device 130 may transmit a first initial CG-SDT transmission, including the RRCResumeRequest message multiplexed with data and possibly a BSR and/or a PHR.

If, at the next CG-SDT resource for the same HARQ process, no acknowledgement of the first initial CG-SDT transmission has been received, the wireless device 130 may select, according to Action 203, a method for retransmission. The method may be one of:
1. A HARQ retransmission, with the same or specified RV;
2. A new first initial CG-SDT transmission containing the same RRCReleaseRequest message and possibly different or updated MAC PDU payload, including possibly an updated BSR and possibly an updated PHR. In embodiments herein, this second option may be called rebuilt retransmission; and

### 3. Trigger Legacy RA or RA-SDT for the Transmission of the Data.

The selection may be configured or specified, according to Action 201, to depend on one, or a combination of the following conditions:
If the cg-SDT-RetransmissionTimer may be configured and may be running;
The periodicity of the CG-SDT resources. For example, if the periodicity or time to next CG-SDT resource for the same HARQ process is larger than a threshold, the rebuilt retransmission may be chosen.
If new data arrives before the next CG-SDT resource for the same HARQ process.
If new data arrives resulting in a different Buffer Size for the BSR before the next CG-SDT resource for the same HARQ process.
If new data arrives with a higher priority, e.g., new data mapped to a (LCH) with higher priority.
If the power headroom changes before the next CG-SDT resource for the same HARQ process.
The first or second method, HARQ retransmission or rebuilding, may always be selected

In one aspect of embodiments herein, the decision of which method to use may be determined, according to Action 204, by the wireless device 130. The decision may depend on the same conditions as above.

### Examples Related to Embodiments Herein:

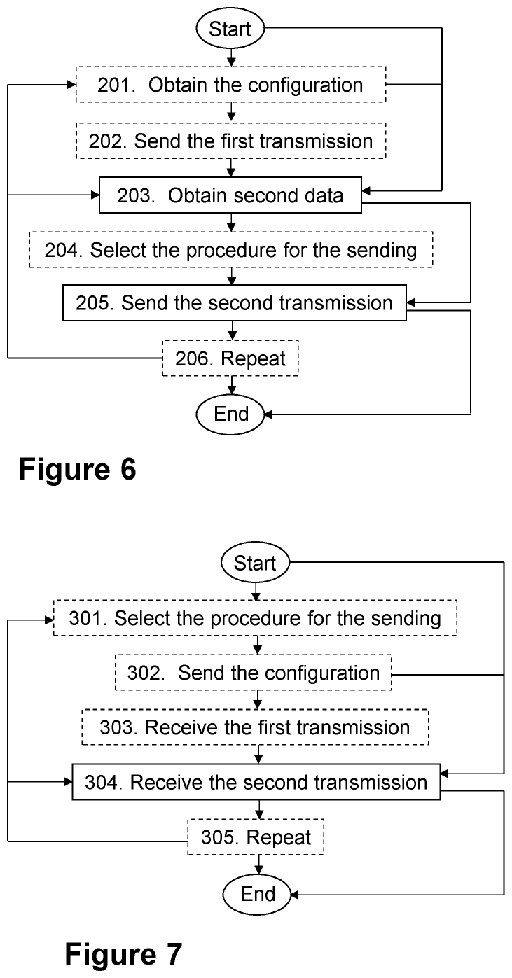

The wireless device 130 embodiments relate to FIG. 6, FIG. 4 and FIGS. 8-13.

A method, performed by a wireless device, such as the wireless device 130 is described herein. The method may be understood to be for handling transmission. The wireless device 130 may be operating in a wireless communications network, such as the wireless communications network 100.

The method may comprise one or more of the following actions.

In some embodiments, all the actions may be performed. In other embodiments, some of the actions may be performed. For example, in some examples, Action 203 and Action 205 may be performed. One or more embodiments may be combined, where applicable. All possible combinations are not described to simplify the description. A non-limiting example of the method performed by the wireless device 130 is depicted in FIG. 6. In FIG. 6, optional actions are represented with dashed lines. The actions may be performed in a different order than that depicted in FIG. 6.
Obtaining 203 data, e.g., second data. The wireless device 130 may be configured to perform the obtaining in this Action 203, e.g. by means of an obtaining unit 403 within the wireless device 130, configured to perform this action.

The data, e.g., second data, may be obtained after a first transmission of first data. The first transmission may be understood to be by the wireless device 130. The first transmission may be in a first subset of a set of periodic uplink time-frequency resources for uplink communication to the network node 110.

A size of a buffer of the wireless device 130 for the uplink transmission of the first data or the second data may be smaller than a threshold. That is, the first data or the second data may be small data. The first data transmission may be a small data transmission, SDT.

The set of periodic uplink time-frequency resources for uplink communication to the network node 110 may be, e.g., a configured grant small data transmission. For example, CG-SDT resource, CG PUSCH resource, or CG configured PUSCH resource, which, may be understood to mean the time, frequency and/or Demodulation Reference Signal (DMRS) resources configured in a configured grant for PUSCH transmissions.

Obtaining may be understood as that the second data may arrive for transmission.

In the absence of having received an acknowledgement from the network node 110 that the first data has been received, the method may further comprise:
Sending 205 a second transmission. The wireless device 130 may be configured to perform the sending in this Action 205, e.g. by means of a sending unit 402 within the wireless device 130, configured to perform this action.

The sending in this Action 205 may be to the network node 110, e.g., via the first link 141.

The second transmission may comprise the second data and a retransmission of the first data.

The sending in this Action 205 of the second transmission may be in a second subset of the set of periodic uplink time-frequency resources. The second subset may be a next subset of the first subset, that is, next in the time dimension.

The first transmission and the second transmission may belong to a same Hybrid Automatic Repeat reQuest (HARQ) process.

In some embodiments, the method may further comprise one or more of the following actions:
Sending 202 the first transmission. The wireless device 130 may be configured to perform the sending in this Action 202, e.g. by means of the sending unit 402 within the wireless device 130, configured to perform this action.

The sending in this Action 202 may be to the network node 110, e.g., via the first link 141.

The first transmission may further comprise at least one of: a message to resume communications, e.g., a RadioResourceControlResumeRequest message, a report on a status of the buffer of the wireless device 130, e.g., a Buffer Status Report (BSR), and a report on a power of the wireless device 130, e.g., a Power Headroom Report (PHR).
Selecting 204 a procedure. The wireless device 130 may be configured to perform the selecting in this Action 204, e.g. by means of a selecting unit 401 within the wireless device 130, configured to perform this action.

The selecting of the procedure may be for the sending in Action 205 of the second data in the second transmission.

The procedure may be one of: i) a HARQ retransmission, ii) an initial transmission comprising the same message to resume communications, e.g., the same RadioResourceControlResumeRequest message, and an initial transmission comprising the same message to resume communications, e.g., the same RadioResourceControlResumeRequest message and at least one of: a Medium Access Control Protocol Data Unit, MAC PDU, an updated MAC PDU, an updated report on the status of the buffer of the wireless device 130, e.g., BSR and an updated report on the power of the wireless device 130, e.g., PHR.

The selecting in this Action 204 may be based on at least one of:
whether or not a timer, e.g., a configured grant small data transmission RetransmissionTimer, cg-SDT-RetransmissionTimer, may be configured and running,
a periodicity of the set of periodic uplink time-frequency resources for uplink communication to the network node 110 of data, wherein the size of the buffer of the wireless device 130 for the uplink transmission of the data is smaller than the threshold,
whether or not the second data is obtained before a subsequent subset of the set of periodic uplink time-frequency resources for uplink communication to the network node 110 of the data for the same HARQ process,
whether or not the second data is obtained resulting in a different Buffer Size for the report on the status of the buffer of the wireless device 130, e.g., BSR, before the next subset of periodic uplink time-frequency resources for uplink communication to the network node 110 of the data for the same HARQ process,
a priority of the second data,
whether or not the power headroom changes before the next subset of periodic uplink time-frequency resources for uplink communication to the network node 110 of the data for the same HARQ process, and
a configuration indicating that the HARQ retransmission or the initial transmission comprising the same message to resume communications, e.g., the same RadioResourceControlResumeRequest message is always selected.

The selecting in this Action 204 may be performed one of: a) autonomously by the wireless device 130, b) based on a configuration, retrieved from a memory, and c) based on the configuration, received from the network node 110.

In some embodiments, with the proviso that only the report on the status of the buffer of the wireless device 130, e.g., the BSR, may be able to be updated for the initial transmission comprising the MAC PDU, the selecting in this Action 204 may be performed autonomously by the wireless device 130.
Repeating 206 any or all of the obtaining of Action 203, the selecting of Action 204 and the sending of Action 205 for third data. The wireless device 130 may be configured to perform the repeating in this Action 206, e.g. by means of a repeating unit 404 within the wireless device 130, configured to perform this action.

The size of the buffer of the wireless device 130 for the uplink transmission of the third data may be smaller than the threshold. The third data may be understood to be small data.

The selected procedure for transmission of the third data may be one of: the same or different than that selected for the second transmission of the second data.

In some examples, the repeating may comprise repeating Action 201, Action 203, e.g., for third data, and Action 205, and optionally, also Action 203. In some examples, the repeating may comprise repeating Action 203 and Action 205.
Obtaining 201 the configuration. The wireless device 130 may be configured to perform the obtaining in this Action 206, e.g. by means of the obtaining unit 403 within the wireless device 130, configured to perform this action.

The obtaining of the configuration may be, e.g., by obtaining an indication.

The obtaining in this Action may be, e.g., from the network node 110, e.g., via the first link 141, e.g., by one of: System Information, in a message to release communications, e.g., a RRCRelease message, and in a Small Data Configured Grant Radio Resource Control configuration.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

Other units 405 may be comprised in the wireless device 130.

The wireless device 130 may also be configured to communicate user data with a host application unit in a host computer 910, e.g., via another link such as 960.

In FIG. 4, optional units are indicated with dashed boxes.

The wireless device 130 may comprise an interface unit to facilitate communications between the wireless device 130 and other nodes or devices, e.g., the network node 110, the host computer 910, or any of the other nodes. In some particular examples, the interface may, for example, include a transceiver configured to transmit and receive radio signals over an air interface in accordance with a suitable standard.

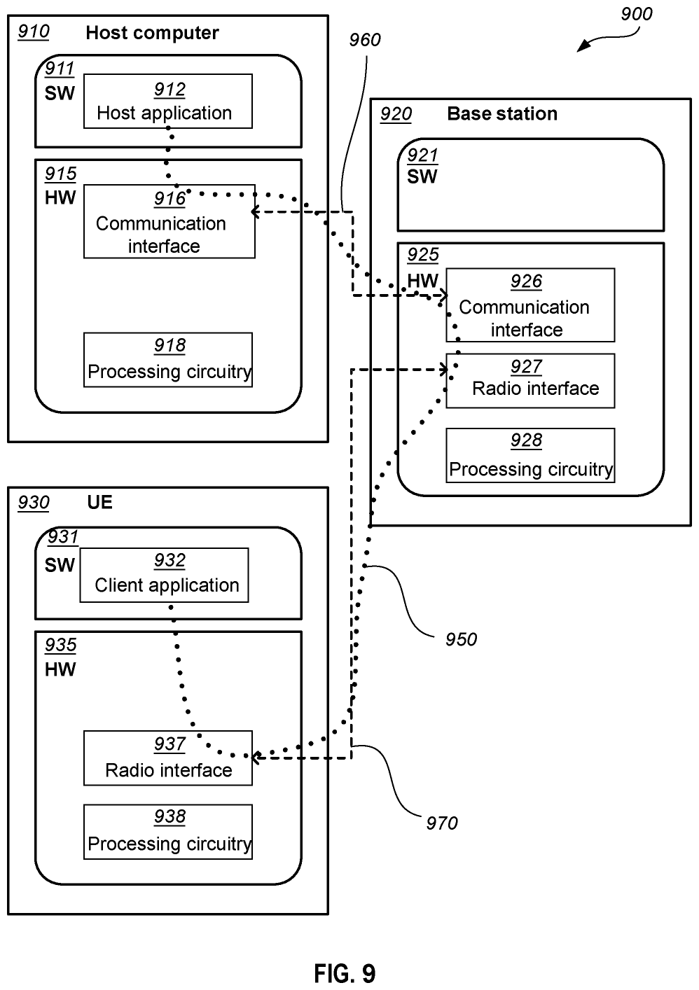

The wireless device 130 may comprise an arrangement as shown in FIG. 4 or in FIG. 9.

The network node 110 embodiments relate to FIG. 7, FIG. 5 and FIGS. 8-13.

A method, performed by a network node, such as the network node 110 is described herein. The method may be understood to be for handling transmission. The network node 110 may be operating in a wireless communications network, such as the wireless communications network 100.

The method may comprise one or more of the following actions.

In some embodiments, all the actions may be performed. In other embodiments, some of the actions may be performed. One or more embodiments may be combined, where applicable.

All possible combinations are not described to simplify the description. A non-limiting example of the method performed by the network node 110 is depicted in FIG. 7. In FIG. 7, optional actions are represented with dashed lines.

The detailed description of some of the following corresponds to the same references provided above, in relation to the actions described for the wireless device 130 and will thus not be repeated here to simplify the description. For example, the set of periodic uplink time-frequency resources for uplink communication to the network node 110 may be, e.g., a configured grant small data transmission. For example, any of the first data, the second data and the third data may be small data.

The actions may be performed in a different order than that depicted in FIG. 7. For example, Action 301 and Action 302 may be performed after Action 303 and before Action 304.
Receiving 304 the second transmission. The network node 110 may be configured to perform the receiving in this Action 304, e.g. by means of a receiving unit 502 within the network node 110, configured to perform this action.

The receiving of the second transmission in this Action 304 may be from the wireless device 130, e.g., via the first link 141.

The second transmission may comprise the second data and the retransmission of the first data.

The receiving in this Action 304 of the second transmission may be in the second subset of the set of periodic uplink time-frequency resources. The second subset may be the next subset of the first subset of the set of periodic uplink time-frequency resources for uplink communication to the network node 110, that is, next in the time dimension.

The size of the buffer of the wireless device 130 for the uplink transmission of the first data or the second data may be smaller than the threshold. That is, the first data or the second data may be small data. The first data transmission may be a small data transmission, SDT.

The first data may have been previously transmitted by the wireless device 130 in the first transmission in the first subset of the set of periodic uplink time-frequency resources for uplink communication to the network node 110.

The first transmission and the second transmission may belong to the same HARQ process.
Receiving 303 the first transmission. The network node 110 may be configured to perform the receiving in this Action 303, e.g. by means of the receiving unit 502 within the network node 110, configured to perform this action.

The receiving in this Action 305 may be from the wireless device 130, e.g., via the first link 141.

The first transmission may further comprise at least one of: the message to resume communications, e.g., the RadioResourceControlResumeRequest message, the report on the status of the buffer of the wireless device 130, e.g., the BSR, and the report on the power of the wireless device 130, e.g., the PHR.

The receiving of the second transmission may be in the absence of one of: a) the network node 110 having sent an acknowledgement to the wireless device 130 that the first data has been received, and b) the wireless device 130 having received the acknowledgement from the network node 110 that the first data has been received.

In some embodiments, the method may further comprise one or more of the following:
Selecting 301 a procedure. The network node 110 may be configured to perform the selecting in this Action 301, e.g. by means of a selecting unit 503 within the network node 110, configured to perform this action.

The selecting of the procedure may be for the sending, by the wireless device 130, of the second data in the second transmission.

The procedure may be one of: i) the HARQ retransmission, ii) the initial transmission comprising the same message to resume communications, e.g., the same RadioResourceControlResumeRequest message, and an initial transmission comprising the same message to resume communications, e.g., the same RadioResourceControlResumeRequest message and at least one of: an Medium Access Control Protocol Data Unit, MAC PDU, an updated MAC PDU, an updated report on the status of the buffer of the wireless device 130, e.g., BSR and an updated report on the power of the wireless device 130, e.g., PHR.

The selecting in this Action 301 may be based on at least one of:
whether or not the timer, e.g., a configured grant small data transmission RetransmissionTimer, cg-SDT-RetransmissionTimer, may be configured and running,
the periodicity of the set of periodic uplink time-frequency resources for uplink communication to the network node 110 of data, wherein the size of the buffer of the wireless device 130 for the uplink transmission of the data is smaller than the threshold,
whether or not the second data is obtained before the subsequent subset of the set of periodic uplink time-frequency resources for uplink communication to the network node 110 of the data for the same HARQ process,
whether or not the second data is obtained resulting in a different Buffer Size for the report on the status of the buffer of the wireless device 130, e.g., BSR, before the next subset of periodic uplink time-frequency resources for uplink communication to the network node 110 of the data for the same HARQ process,
the priority of the second data,
whether or not the power headroom changes before the next subset of periodic uplink time-frequency resources for uplink communication to the network node 110 of the data for the same HARQ process, and
the configuration indicating that the HARQ retransmission or the initial transmission comprising the same message to resume communications, e.g., the same RadioResourceControlResumeRequest message is always selected.

In some embodiments, with the proviso that only the report on the status of the buffer of the wireless device 130, e.g., the BSR, may be able to be updated for the initial transmission comprising the MAC PDU, the receiving in this Action 304 of the second transmission may be performed based on the procedure as selected autonomously by the wireless device 130.

In some embodiments, the method may comprise, e.g., further comprise, one or more of the following actions:
Repeating 305 any or all of the selecting of Action 301, the sending of Action 302 and the receiving of Action 304 for third data. The network node 110 may be configured to perform the repeating of this Action 305, e.g. by means of a repeating unit 504 within the network node 110, configured to perform this action.

The size of the buffer of the wireless device 130 for the uplink transmission of the third data may be smaller than the threshold. The third data may be understood to be small data.

The selected procedure for transmission of the third data may be one of: the same or different than that selected for the second transmission of the second data.

The receiving of Action 304 of the second transmission may be performed based on the procedure selected by the network node 110 and provided to the wireless device 130, e.g., in the configuration sent from the network node 110.

In some examples, the repeating may comprise repeating Action 304, and optionally, also Action 301 and Action 302.
Sending 302 the configuration. The network node 110 may be configured to perform the sending in this Action 302, e.g. by means of a sending unit 501 within the network node 110, configured to perform this action.

The sending of the configuration in this Action 302 may be to the wireless device 130.

The sending in this Action 302 may be performed, e.g., via the first link 141.

The sending of the configuration may be, e.g., by sending an indication.

The sending in this Action 302 of the configuration may be e.g., by one of: System Information, in the message to release communications, e.g., the RRCRelease message, and in the Small Data Configured Grant Radio Resource Control configuration.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

Other units 505 may be comprised in the network node 110.

The network node 110 may also be configured to communicate user data with a host application unit in a host computer 910, e.g., via another link such as 960.

In FIG. 5, optional units are indicated with dashed boxes.

The network node 110 may comprise an interface unit to facilitate communications between the network node 110 and other nodes or devices, e.g., the wireless device 130, the host computer 910, or any of the other nodes. In some particular examples, the interface may, for example, include a transceiver configured to transmit and receive radio signals over an air interface in accordance with a suitable standard.

The network node 110 may comprise an arrangement as shown in FIG. 5 or in FIG. 9.

### Selected Examples Related to Embodiments Herein:

Example 1. A method performed by a wireless device (130), the method being for handling transmission, the wireless device (130) operating in a wireless communications network (100), and the method comprising:
obtaining (203), after a first transmission of first data in a first subset of a set of periodic uplink time-frequency resources for uplink communication to a network node (110), second data, wherein a size of a buffer of the wireless device (130) for the uplink transmission of the first data or the second data is smaller than a threshold, and, in the absence of having received an acknowledgement from the network node (110) that the first data has been received,
sending (205) a second transmission to the network node (110), the second transmission comprising the second data and a retransmission of the first data, the sending (205) of the second transmission being in a second subset of the set of periodic uplink time-frequency resources, the second subset being a next subset of the first subset.

Example 2. The method according to example 1, wherein the first transmission and the second transmission belong to a same Hybrid Automatic Repeat reQuest, HARQ, process.

Example 3. The method according to any of examples 1-2, further comprising:
sending (202) the first transmission, the first transmission further comprising at least one of: a message to resume communications, e.g., a RadioResourceControlResumeRequest message, a report on the status of the buffer of the wireless device 130, e.g., a Buffer Status Report, BSR, and a report on the power of the wireless device 130, e.g., Power Headroom Report, PHR.

Example 4. The method according to example 3, further comprising, after obtaining the second data:
selecting (204) a procedure for the sending (205) of the second data in the second transmission, the procedure being one of:
   i. a HARQ retransmission,
   ii. an initial transmission comprising the same message to resume communications, e.g., the same RadioResourceControlResumeRequest message, and
   iii. an initial transmission comprising the same message to resume communications, e.g., the same RadioResourceControlResumeRequest message and at least one of: a Medium Access Control Protocol Data Unit, MAC PDU, an updated MAC PDU, an updated report on the status of the buffer of the wireless device 130, e.g., BSR, and an updated report on the power of the wireless device 130, e.g., PHR.

Example 5. The method according to example 4, wherein the selecting (204) is based on at least one of:
whether or not a configured timer, e.g., a grant small data transmission RetransmissionTimer, cg-SDT-RetransmissionTimer, is configured and running,
a periodicity of the set of periodic uplink time-frequency resources for uplink communication to the network node (110) of data, wherein the size of the buffer of the wireless device (130) for the uplink transmission of the data is smaller than the threshold,
whether or not the second data is obtained before a subsequent subset of the set of periodic uplink time-frequency resources for uplink communication to the network node (110) of the data for the same HARQ process,
whether or not the second data is obtained resulting in a different Buffer Size for the report on the status of the buffer of the wireless device 130, e.g., BSR, before the next subset of periodic uplink time-frequency resources for uplink communication to the network node (110) of the data for the same HARQ process,
a priority of the second data,
whether or not the power headroom changes before the next subset of periodic uplink time-frequency resources for uplink communication to the network node (110) of the data for the same HARQ process, and
a configuration indicating that the HARQ retransmission or the initial transmission comprising the same message to resume communications, e.g., the same RadioResourceControlResumeRequest message is always selected.

Example 6. The method according to any of examples 4-5, further comprising:
repeating (206) the obtaining (203), the selecting (204) and the sending (205) for third data, wherein the size of the buffer of the wireless device (130) for the uplink transmission of the third data is smaller than the threshold, and wherein the selected procedure for transmission of the third data is one of: the same or different than that selected for the second transmission of the second data.

Example 7. The method according to any of examples 4-6, wherein the selecting (204) is performed one of: a) autonomously by the wireless device (130), b) based on a configuration, retrieved from a memory, and c) based on the configuration, received from the network node (110).

Example 8. The method according to example 7, further comprising:
obtaining (201) the configuration, e.g., from the network node (110), e.g., by one of: System Information, in a message to release communications, e.g., a RRCRelease message, and in a Small Data Configured Grant Radio Resource Control configuration.

Example 9. The method according to any of examples 4-8, wherein, with the proviso that only the report on the status of the buffer of the wireless device 130, e.g., BSR, is able to be updated for the initial transmission comprising the MAC PDU, the selecting (204) is performed autonomously by the wireless device (130).

Example 10. A method performed by a network node (110), the method being for handling transmission, the network node (110) operating in a wireless communications network (100), and the method comprising:
receiving (304) a second transmission from a wireless device (130), the second transmission comprising second data and a retransmission of first data, the receiving (304) of the second transmission being in a second subset of a set of periodic uplink time-frequency resources, the second subset being a next subset of a first subset of the set of periodic uplink time-frequency resources for uplink communication to the network node (110), wherein a size of a buffer of the wireless device (130) for the uplink transmission of the first data or the second data is smaller than a threshold.

Example 11. The method according to example 10, wherein the first data has been previously transmitted by the wireless device (130) in a first transmission in a first subset of the set of periodic uplink time-frequency resources for uplink communication to a network node (110), and wherein the first transmission and the second transmission belong to a same Hybrid Automatic Repeat reQuest, HARQ, process.

Example 12. The method according to any of examples 10-11, further comprising:
receiving (303) the first transmission from the wireless device (130), the first transmission further comprising at least one of: a message to resume communications, e.g., a RadioResourceControlResumeRequest message, a report on the status of the buffer of the wireless device 130, e.g., a Buffer Status Report, BSR, and a report on the power of the wireless device 130, e.g., Power Headroom Report, PHR, and wherein the receiving of the second transmission is in the absence of one of: a) the network node (110) having sent an acknowledgement to the wireless device (130) that the first data has been received, and b) the wireless device (130) having received an acknowledgement from the network node (110) that the first data has been received.

Example 13. The method according to example 12, further comprising:
selecting (301) a procedure for the sending, by the wireless device (130), of the second data in the second transmission, the procedure being one of:
   i. a HARQ retransmission,
   ii. an initial transmission comprising the same message to resume communications, e.g., the same RadioResourceControlResumeRequest message, and
   iii. an initial transmission comprising the same message to resume communications, e.g., the same RadioResourceControlResumeRequest message and at least one of: a Medium Access Control Protocol Data Unit, MAC PDU, an updated MAC PDU, an updated report on the status of the buffer of the wireless device 130, e.g., BSR, and an updated report on the power of the wireless device 130, e.g., PHR.

Example 14. The method according to example 13, wherein the selecting (301) is based on at least one of:
whether or not a configured timer, e.g., a grant small data transmission RetransmissionTimer, cg-SDT-RetransmissionTimer, is configured and running,
a periodicity of the set of periodic uplink time-frequency resources for uplink communication to the network node (110) of data, wherein the size of the buffer of the wireless device (130) for the uplink transmission of the data is smaller than the threshold,
whether or not the second data is obtained by the wireless device (130) before a subsequent subset of the set of periodic uplink time-frequency resources for uplink communication to the network node (110) of the data for the same HARQ process,
whether or not the second data is obtained resulting in a different Buffer Size for the report on the status of the buffer of the wireless device 130, e.g., BSR, before the next subset of periodic uplink time-frequency resources for uplink communication to the network node (110) of the data for the same HARQ process,
a priority of the second data,
whether or not the power headroom changes before the next subset of periodic uplink time-frequency resources for uplink communication to the network node (110) of the data for the same HARQ process, and
a configuration indicating that the HARQ retransmission or the initial transmission comprising the same message to resume communications, e.g., the same RadioResourceControlResumeRequest message is always selected.

Example 15. The method according to any of examples 13-14, further comprising:
repeating (305) the selecting (301), the sending (302) and the receiving (304) for third data, wherein the size of the buffer of the wireless device (130) for the uplink transmission of the third data is smaller than the threshold, and wherein the selected procedure for transmission of the third data is one of: the same or different than that selected for the second transmission of the second data.

Example 16. The method according to any of examples 13-15, wherein the receiving (304) of the second transmission is performed based on the procedure selected by the network node (110) and provided to the wireless device (130), e.g., in a configuration sent from the network node (110).

Example 17. The method according to example 16, further comprising:
sending (302) the configuration, e.g., to the wireless device 130, e.g., by one of: System Information, in a message to release communications, e.g., a RRCRelease message, and in a Small Data Configured Grant Radio Resource Control configuration.

Example 18. The method according to any of examples 13-17, wherein, with the proviso that only the report on the status of the buffer of the wireless device 130, e.g., BSR, is able to be updated for the initial transmission comprising the MAC PDU, the receiving (304) of the second transmission is performed based on the procedure as selected autonomously by the wireless device (130).

### Further Extensions and Variations

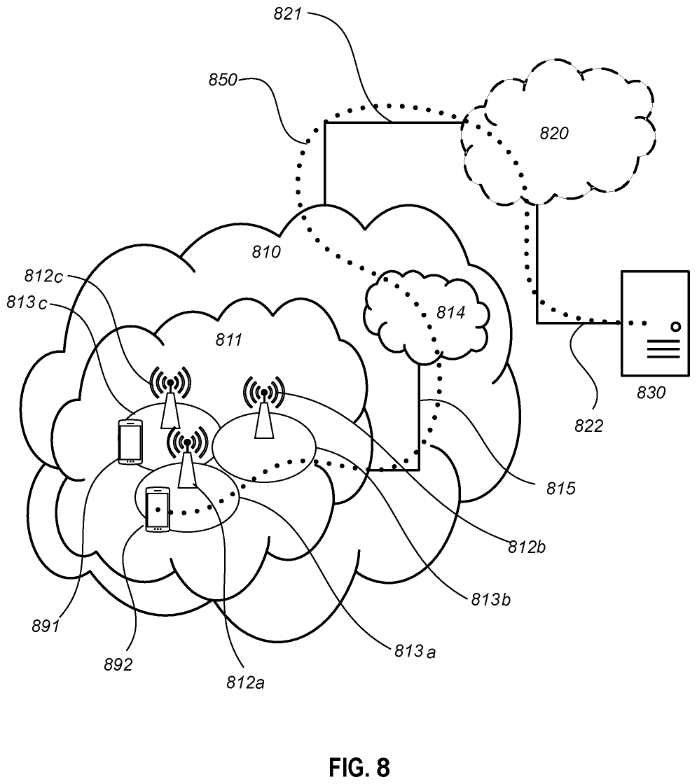

FIG. 8: Telecommunication network connected via an intermediate network to a host computer in accordance with some embodiments

With reference to FIG. 8, in accordance with an embodiment, a communication system includes telecommunication network 810 such as the wireless communications network 100, for example, a 3GPP-type cellular network, which comprises access network 811, such as a radio access network, and core network 814. Access network 811 comprises a plurality of network nodes such as the network node 110. For example, base stations 812a, 812b, 812c, such as NBs, eNBs, gNBs or other types of wireless access points, each defining a corresponding coverage area 813a, 813b, 813c. Each base station 812a, 812b, 812c is connectable to core network 814 over a wired or wireless connection 815. A plurality of user equipments, such as the wireless device 130 are comprised in the wireless communications network 100. In FIG. 8, a first UE 891 located in coverage area 813c is configured to wirelessly connect to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812. Any of the UEs 891, 892 are examples of the wireless device 130.

Telecommunication network 810 is itself connected to host computer 830, which may be embodied in the hardware and/or software of a standalone server, a cloud-implemented server, a distributed server or as processing resources in a server farm. Host computer 830 may be under the ownership or control of a service provider, or may be operated by the service provider or on behalf of the service provider. Connections 821 and 822 between telecommunication network 810 and host computer 830 may extend directly from core network 814 to host computer 830 or may go via an optional intermediate network 820. Intermediate network 820 may be one of, or a combination of more than one of, a public, private or hosted network; intermediate network 820, if any, may be a backbone network or the Internet; in particular, intermediate network 820 may comprise two or more sub-networks (not shown).

The communication system of FIG. 8 as a whole enables connectivity between the connected UEs 891, 892 and host computer 830. The connectivity may be described as an over-the-top (OTT) connection 850. Host computer 830 and the connected UEs 891, 892 are configured to communicate data and/or signaling via OTT connection 850, using access network 811, core network 814, any intermediate network 820 and possible further infrastructure (not shown) as intermediaries. OTT connection 850 may be transparent in the sense that the participating communication devices through which OTT connection 850 passes are unaware of routing of uplink and downlink communications. For example, base station 812 may not or need not be informed about the past routing of an incoming downlink communication with data originating from host computer 830 to be forwarded (e.g., handed over) to a connected UE 891.

Similarly, base station 812 need not be aware of the future routing of an outgoing uplink communication originating from the UE 891 towards the host computer 830.

In relation to FIGS. 9, 10, 11, 12, and 13, which are described next, it may be understood that a UE is an example of the wireless device 130, and that any description provided for the UE equally applies to the wireless device 130. It may be also understood that the base station is an example of the network node 110, and that any description provided for the base station equally applies to the network node 110.

FIG. 9: Host computer communicating via a base station with a user equipment over a partially wireless connection in accordance with some embodiments

Example implementations, in accordance with an embodiment, of the wireless device 130, e.g., a UE, the network node 110, e.g., a base station and host computer discussed in the preceding paragraphs will now be described with reference to FIG. 9. In communication system 900, such as the wireless communications network 100, host computer 910 comprises hardware 915 including communication interface 916 configured to set up and maintain a wired or wireless connection with an interface of a different communication device of communication system 900. Host computer 910 further comprises processing circuitry 918, which may have storage and/or processing capabilities. In particular, processing circuitry 918 may comprise one or more programmable processors, application-specific integrated circuits, field programmable gate arrays or combinations of these (not shown) adapted to execute instructions. Host computer 910 further comprises software 911, which is stored in or accessible by host computer 910 and executable by processing circuitry 918. Software 911 includes host application 912. Host application 912 may be operable to provide a service to a remote user, such as UE 930 connecting via OTT connection 950 terminating at UE 930 and host computer 910. In providing the service to the remote user, host application 912 may provide user data which is transmitted using OTT connection 950.

Communication system 900 further includes the network node 110, exemplified in FIG. 9 as a base station 920 provided in a telecommunication system and comprising hardware 925 enabling it to communicate with host computer 910 and with UE 930. Hardware 925 may include communication interface 926 for setting up and maintaining a wired or wireless connection with an interface of a different communication device of communication system 900, as well as radio interface 927 for setting up and maintaining at least wireless connection 970 with the wireless device 130, exemplified in FIG. 9 as a UE 930 located in a coverage area (not shown in FIG. 9) served by base station 920. Communication interface 926 may be configured to facilitate connection 960 to host computer 910. Connection 960 may be direct or it may pass through a core network (not shown in FIG. 9) of the telecommunication system and/or through one or more intermediate networks outside the telecommunication system. In the embodiment shown, hardware 925 of base station 920 further includes processing circuitry 928, which may comprise one or more programmable processors, application-specific integrated circuits, field programmable gate arrays or combinations of these (not shown) adapted to execute instructions. Base station 920 further has software 921 stored internally or accessible via an external connection.

Communication system 900 further includes UE 930 already referred to. Its hardware 935 may include radio interface 937 configured to set up and maintain wireless connection 970 with a base station serving a coverage area in which UE 930 is currently located. Hardware 935 of UE 930 further includes processing circuitry 938, which may comprise one or more programmable processors, application-specific integrated circuits, field programmable gate arrays or combinations of these (not shown) adapted to execute instructions. UE 930 further comprises software 931, which is stored in or accessible by UE 930 and executable by processing circuitry 938. Software 931 includes client application 932. Client application 932 may be operable to provide a service to a human or non-human user via UE 930, with the support of host computer 910. In host computer 910, an executing host application 912 may communicate with the executing client application 932 via OTT connection 950 terminating at UE 930 and host computer 910. In providing the service to the user, client application 932 may receive request data from host application 912 and provide user data in response to the request data. OTT connection 950 may transfer both the request data and the user data. Client application 932 may interact with the user to generate the user data that it provides.

It is noted that host computer 910, base station 920 and UE 930 illustrated in FIG. 9 may be similar or identical to host computer 830, one of base stations 812a, 812b, 812c and one of UEs 891, 892 of FIG. 8, respectively. This is to say, the inner workings of these entities may be as shown in FIG. 9 and independently, the surrounding network topology may be that of FIG. 8.

In FIG. 9, OTT connection 950 has been drawn abstractly to illustrate the communication between host computer 910 and UE 930 via base station 920, without explicit reference to any intermediary devices and the precise routing of messages via these devices. Network infrastructure may determine the routing, which it may be configured to hide from UE 930 or from the service provider operating host computer 910, or both. While OTT connection 950 is active, the network infrastructure may further take decisions by which it dynamically changes the routing (e.g., on the basis of load balancing consideration or reconfiguration of the network).

Wireless connection 970 between UE 930 and base station 920 is in accordance with the teachings of the embodiments described throughout this disclosure. One or more of the various embodiments improve the performance of OTT services provided to UE 930 using OTT connection 950, in which wireless connection 970 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 950 between host computer 910 and UE 930, in response to variations in the measurement results. The measurement procedure and/or the network functionality for reconfiguring OTT connection 950 may be implemented in software 911 and hardware 915 of host computer 910 or in software 931 and hardware 935 of UE 930, or both. In embodiments, sensors (not shown) may be deployed in or in association with communication devices through which OTT connection 950 passes; the sensors may participate in the measurement procedure by supplying values of the monitored quantities exemplified above, or supplying values of other physical quantities from which software 911, 931 may compute or estimate the monitored quantities. The reconfiguring of OTT connection 950 may include message format, retransmission settings, preferred routing etc.; the reconfiguring need not affect base station 920, and it may be unknown or imperceptible to base station 920. Such procedures and functionalities may be known and practiced in the art. In certain embodiments, measurements may involve proprietary UE signaling facilitating host computer 910's measurements of throughput, propagation times, latency and the like. The measurements may be implemented in that software 911 and 931 causes messages to be transmitted, in particular empty or ‘dummy’ messages, using OTT connection 950 while it monitors propagation times, errors etc.

The wireless device 130 embodiments relate to FIG. 2, FIG. 4, FIG. 6 and FIGS. 8-13.

In FIG. 4, optional units are indicated with dashed boxes.

The wireless device 130 may also be configured to communicate user data with a host application unit in a host computer 910, e.g., via another link such as 960.

The wireless device 130 may comprise an interface unit to facilitate communications between the wireless device 130 and other nodes or devices, e.g., the network node 110, the host computer 910, or any of the other nodes. In some particular examples, the interface may, for example, include a transceiver configured to transmit and receive radio signals over an air interface in accordance with a suitable standard.

The wireless device 130 may comprise an arrangement as shown in FIG. 4 or in FIG. 9.

The network node 110 embodiments relate to FIG. 3, FIG. 5, FIG. 7 and FIGS. 8-13.

The network node 110 may also be configured to communicate user data with a host application unit in a host computer 910, e.g., via another link such as 960.

The network node 110 may comprise an interface unit to facilitate communications between the network node 110 and other nodes or devices, e.g., the wireless device 130, the host computer 910, or any of the other nodes. In some particular examples, the interface may, for example, include a transceiver configured to transmit and receive radio signals over an air interface in accordance with a suitable standard.

The network node 110 may comprise an arrangement as shown in FIG. 5 or in FIG. 9.

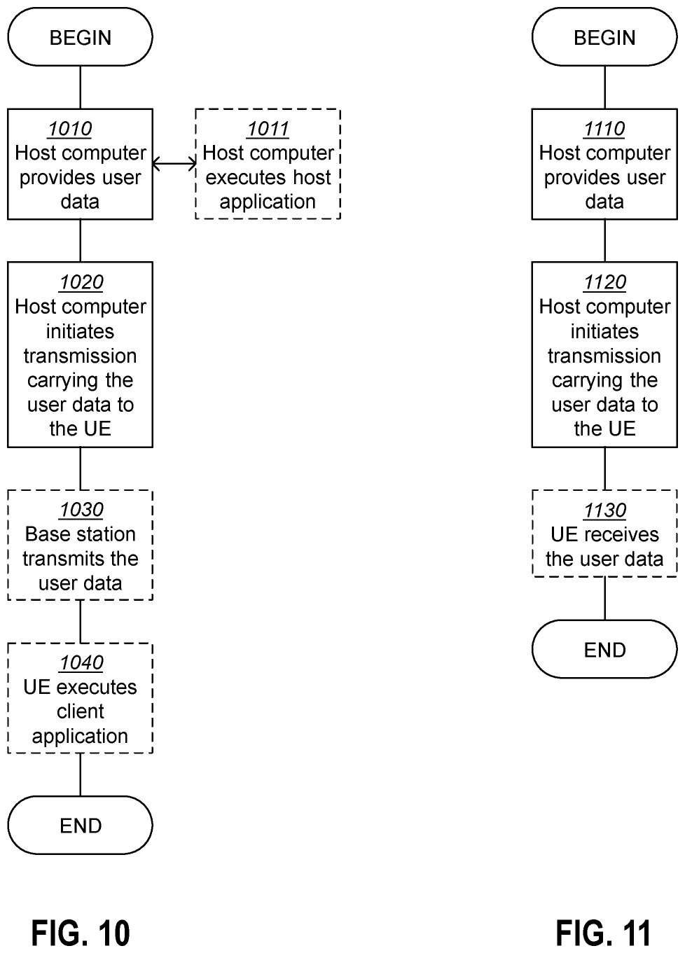

FIG. 10: Methods implemented in a communication system including a host computer, a base station and a user equipment in accordance with some embodiments

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In step 1010, the host computer provides user data. In substep 1011 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

FIG. 11: Methods implemented in a communication system including a host computer, a base station and a user equipment in accordance with some embodiments FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

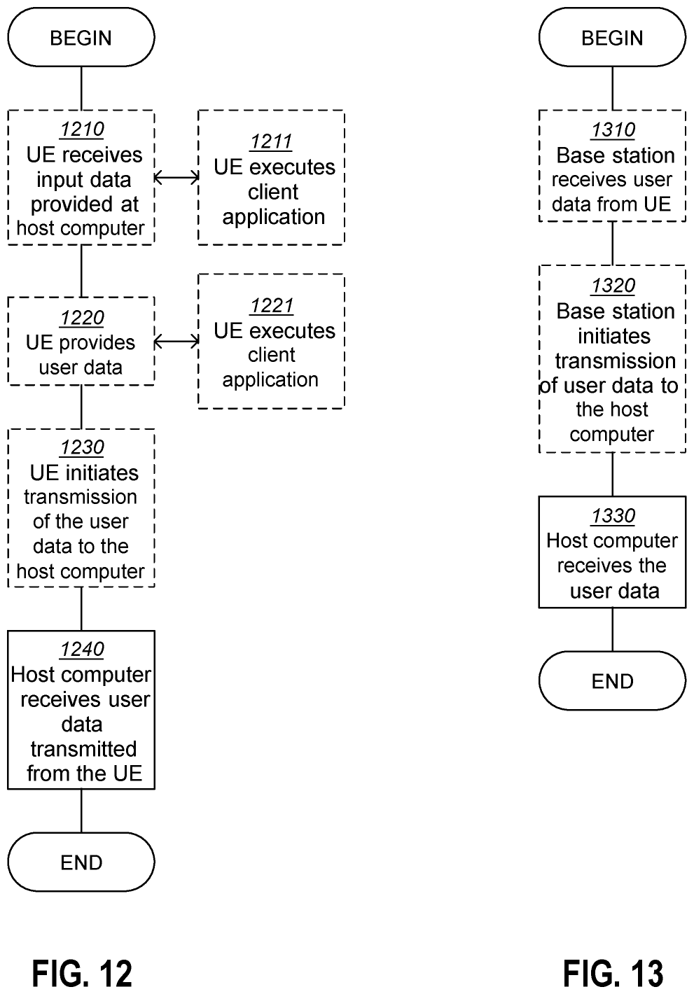

FIG. 12: Methods implemented in a communication system including a host computer, a base station and a user equipment in accordance with some embodiments

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

FIG. 13: Methods implemented in a communication system including a host computer, a base station and a user equipment in accordance with some embodiments

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by the network node 110.

5. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform one or more of the actions described herein as performed by the network node 110.

6. The communication system of embodiment 5, further including the base station.

7. The communication system of embodiment 6, further including the UE, wherein the UE is configured to communicate with the base station.

8. The communication system of embodiment 7, wherein:
the processing circuitry of the host computer is configured to execute a host application, thereby providing the user data; and
the UE comprises processing circuitry configured to execute a client application associated with the host application.

11. A method implemented in a base station, comprising one or more of the actions described herein as performed by the network node 110.

15. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs one or more of the actions described herein as performed by the network node 110.

16. The method of embodiment 15, further comprising:
at the base station, transmitting the user data.

17. The method of embodiment 16, wherein the user data is provided at the host computer by executing a host application, the method further comprising:
at the UE, executing a client application associated with the host application.

21. A user equipment (UE) configured to communicate with a base station, the UE comprising a radio interface and processing circuitry configured to perform one or more of the actions described herein as performed by the wireless device 130.

25. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's processing circuitry configured to perform one or more of the actions described herein as performed by the wireless device 130.

26. The communication system of embodiment 25, further including the UE.

27. The communication system of embodiment 26, wherein the cellular network further includes a base station configured to communicate with the UE.

28. The communication system of embodiment 26 or 27, wherein:
the processing circuitry of the host computer is configured to execute a host application, thereby providing the user data; and
the UE's processing circuitry is configured to execute a client application associated with the host application.

31. A method implemented in a user equipment (UE), comprising one or more of the actions described herein as performed by the wireless device 130.

35. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs one or more of the actions described herein as performed by the wireless device 130.

36. The method of embodiment 35, further comprising:
at the UE, receiving the user data from the base station.

41. A user equipment (UE) configured to communicate with a base station, the UE comprising a radio interface and processing circuitry configured to perform one or more of the actions described herein as performed by the wireless device 130.

45. A communication system including a host computer comprising:
a communication interface configured to receive user data originating from a transmission from a user equipment (UE) to a base station,
wherein the UE comprises a radio interface and processing circuitry, the UE's processing circuitry configured to: perform one or more of the actions described herein as performed by the wireless device 130.

46. The communication system of embodiment 45, further including the UE.

47. The communication system of embodiment 46, further including the base station, wherein the base station comprises a radio interface configured to communicate with the UE and a communication interface configured to forward to the host computer the user data carried by a transmission from the UE to the base station.

48. The communication system of embodiment 46 or 47, wherein:
the processing circuitry of the host computer is configured to execute a host application; and
the UE's processing circuitry is configured to execute a client application associated with the host application, thereby providing the user data.

49. The communication system of embodiment 46 or 47, wherein:
the processing circuitry of the host computer is configured to execute a host application, thereby providing request data; and
the UE's processing circuitry is configured to execute a client application associated with the host application, thereby providing the user data in response to the request data.

51. A method implemented in a user equipment (UE), comprising one or more of the actions described herein as performed by the wireless device 130.

52. The method of embodiment 51, further comprising:
providing user data; and forwarding the user data to a host computer via the transmission to the base station.

55. A method implemented in a communication system including a host computer, a base station and a user equipment (UE), the method comprising:
at the host computer, receiving user data transmitted to the base station from the UE, wherein the UE performs one or more of the actions described herein as performed by the wireless device 130.

56. The method of embodiment 55, further comprising:
at the UE, providing the user data to the base station.

57. The method of embodiment 56, further comprising:
at the UE, executing a client application, thereby providing the user data to be transmitted; and
at the host computer, executing a host application associated with the client application.

58. The method of embodiment 56, further comprising:
at the UE, executing a client application; and
at the UE, receiving input data to the client application, the input data being provided at the host computer by executing a host application associated with the client application,
wherein the user data to be transmitted is provided by the client application in response to the input data.

61. A base station configured to communicate with a user equipment (UE), the base station comprising a radio interface and processing circuitry configured to perform one or more of the actions described herein as performed by the network node 110.

65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by the network node 110.

66. The communication system of embodiment 65, further including the base station.

67. The communication system of embodiment 66, further including the UE, wherein the UE is configured to communicate with the base station.

68. The communication system of embodiment 67, wherein:
the processing circuitry of the host computer is configured to execute a host application;
the UE is configured to execute a client application associated with the host application, thereby providing the user data to be received by the host computer.

71. A method implemented in a base station, comprising one or more of the actions described herein as performed by the network node 110.

75. A method implemented in a communication system including a host computer, a base station and a user equipment (UE), the method comprising:
at the host computer, receiving, from the base station, user data originating from a transmission which the base station has received from the UE, wherein the UE performs one or more of the actions described herein as performed by the wireless device 130.

76. The method of embodiment 75, further comprising:
at the base station, receiving the user data from the UE.

77. The method of embodiment 76, further comprising:
at the base station, initiating a transmission of the received user data to the host computer.

1-36. (canceled)

37. A method performed by a wireless device, the method being for handling transmission, the wireless device operating in a wireless communications network, and the method comprising:
after a first transmission of first data in a first subset of a set of periodic uplink time-frequency resources for uplink communication to a network node, wherein a size of a buffer of the wireless device for the uplink transmission of the first data is smaller than a threshold, and, in the absence of having received an acknowledgement from the network node that the first data has been received,
selecting a procedure for sending a second transmission to the network node, the procedure being one of:
i. a Hybrid Automatic Repeat reQuest (HARQ) retransmission,
ii. an initial transmission comprising a same message to resume communications as a message to resume communications comprised in the first transmission,
iii. the initial transmission comprising the same message to resume communications and at least one of: a Medium Access Control Protocol Data Unit (MAC PDU), an updated MAC PDU, an updated report on a status of the buffer of the wireless device with respect to a report on the status of the buffer of the wireless device comprised in the first transmission, and an updated report on the power of the wireless device with respect to a report on the power of the wireless device comprised in the first transmission, and
iv. a random access or random access of small data transmission for the transmission of the data, and
sending the second transmission to the network node, the sending of the second transmission being in a second subset of the set of periodic uplink time-frequency resources, the second subset being a next subset of the first subset.

38. The method of claim 37, wherein the selecting is based on at least one of:
a. whether or not a configured timer is configured and running,
b. a periodicity of the set of periodic uplink time-frequency resources for uplink communication to the network node of data, wherein the size of the buffer of the wireless device for the uplink transmission of the data is smaller than the threshold,
c. whether or not second data is obtained before a subsequent subset of the set of periodic uplink time-frequency resources for uplink communication to the network node of the data for the same HARQ process,
d. whether or not the second data is obtained resulting in a different Buffer Size for the report on the status of the buffer of the wireless device before the next subset of periodic uplink time-frequency resources for uplink communication to the network node of the data for the same HARQ process,
e. a priority of the second data,
f. whether or not the power headroom changes before the next subset of periodic uplink time-frequency resources for uplink communication to the network node of the data for the same HARQ process, and
g. a first configuration, the first configuration indicating that the HARQ retransmission or the initial transmission comprising the same message to resume communications is always selected.

39. The method of claim 37, wherein the first transmission and the second transmission belong to a same HARQ process.

40. The method of claim 37, further comprising:
a. sending the first transmission, the first transmission further comprising at least one of:
the message to resume communications, the report on the status of the buffer of the wireless device, and the report on the power of the wireless device, and
b. obtaining second data, and
wherein the selecting the procedure is performed after obtaining the second data.

41. The method of claim 40, further comprising:
a. repeating the obtaining, the selecting and the sending for third data, and wherein the selected procedure for transmission of the third data is one of: the same or different than that selected for the second transmission.

42. The method of claim 37, wherein, with the proviso that only the report on the status of the buffer of the wireless device is able to be updated for the initial transmission comprising the MAC PDU, the selecting is performed autonomously by the wireless device.

43. A method performed by a network node, the method being for handling transmission, the network node operating in a wireless communications network, and the method comprising:
a. sending a configuration to a wireless device, wherein the wireless device is to perform a selection based on the configuration, wherein the selection is of a procedure for, after a first transmission by the wireless device of first data in a first subset of a set of periodic uplink time-frequency resources for uplink communication to the network node, wherein a size of a buffer of the wireless device for the uplink transmission of the first data is smaller than a threshold, and, in the absence of having received an acknowledgement from the network node that the first data has been received, sending a second transmission to the network node, the procedure being one of:
i. a Hybrid Automatic Repeat reQuest (HARQ) retransmission,
ii. an initial transmission comprising a same message to resume communications as a message to resume communications comprised in the first transmission,
iii. the initial transmission comprising the same message to resume communications and at least one of: a Medium Access Control Protocol Data Unit (MAC PDU), an updated MAC PDU, an updated report on a status of the buffer of the wireless device with respect to a report on the status of the buffer of the wireless device comprised in the first transmission, and an updated report on the power of the wireless device with respect to a report on the power of the wireless device comprised in the first transmission, and
iv. a random access or random access of small data transmission for the transmission of the data.

44. The method of claim 43, wherein the selecting by the wireless device is to be based on at least one of:
a. whether or not a configured timer is configured and running,
b. a periodicity of the set of periodic uplink time-frequency resources for uplink communication to the network node of data, wherein the size of the buffer of the wireless device for the uplink transmission of the data is smaller than the threshold,
c. whether or not second data is obtained by the wireless device before a subsequent subset of the set of periodic uplink time-frequency resources for uplink communication to the network node of the data for the same HARQ process,
d. whether or not the second data is obtained by the wireless device resulting in a different Buffer Size for the report on the status of the buffer of the wireless device before the next subset of periodic uplink time-frequency resources for uplink communication to the network node of the data for the same HARQ process,
e. a priority of the second data,
f. whether or not the power headroom changes before the next subset of periodic uplink time-frequency resources for uplink communication to the network node of the data for the same HARQ process, and
g. a first configuration, the first configuration indicating that the HARQ retransmission or the initial transmission comprising the same message to resume communications is always selected.

45. The method of claim 43, further comprising:
a. receiving a second transmission from the wireless device, the receiving of the second transmission being in a second subset of the set of periodic uplink time-frequency resources, the second subset being a next subset of the first subset of the set of periodic uplink time-frequency resources for uplink communication to the network node.

46. The method of claim 45, wherein at least one of:
a. the first data has been previously transmitted by the wireless device in the first transmission in the first subset of the set of periodic uplink time-frequency resources for uplink communication to the network node, and wherein the first transmission and the second transmission belong to a same Hybrid Automatic Repeat reQuest, HARQ, process, and
b. the second transmission comprises second data and a retransmission of the first data.

47. The method of claim 45, further comprising:
a. receiving the first transmission from the wireless device, the first transmission further comprising at least one of: a message to resume communications, a report on the status of the buffer of the wireless device, and a report on the power of the wireless device, and wherein the receiving of the second transmission is in the absence of one of: a) the network node having sent the acknowledgement to the wireless device that the first data has been received, and b) the wireless device having received the acknowledgement from the network node that the first data has been received.

48. The method of claim 43, further comprising:
a. selecting the procedure for the sending, by the wireless device, of the second transmission, the procedure being one of:
i. the HARQ retransmission,
ii. the initial transmission comprising the same message to resume communications,
iii. the initial transmission comprising the same message to resume communications, and at least one of: the MAC PDU, the updated MAC PDU, the updated report on the status of the buffer of the wireless device, and the updated report on the power of the wireless device, and
iv. the random access or random access of small data transmission for the transmission of the data.

49. The method of claim 48, wherein the selecting by the network node is based on at least one of:
a. whether or not the configured timer, is configured and running,
b. the periodicity of the set of periodic uplink time-frequency resources for uplink communication to the network node of data, wherein the size of the buffer of the wireless device for the uplink transmission of the data is smaller than the threshold,
c. whether or not second data is obtained by the wireless device before the subsequent subset of the set of periodic uplink time-frequency resources for uplink communication to the network node of the data for the same HARQ process,
d. whether or not the second data is obtained resulting in a different Buffer Size for the report on the status of the buffer of the wireless device, before the next subset of periodic uplink time-frequency resources for uplink communication to the network node of the data for the same HARQ process,
e. the priority of the second data,
f. whether or not the power headroom changes before the next subset of periodic uplink time-frequency resources for uplink communication to the network node of the data for the same HARQ process, and
g. the first configuration indicating that the HARQ retransmission or the initial transmission comprising the same message to resume communications is always selected.

50. The method of claim 48, further comprising:
a. repeating the selecting, the sending and the receiving for third data, wherein the size of the buffer of the wireless device for the uplink transmission of the third data is smaller than the threshold, and wherein the selected procedure for transmission of the third data is one of: the same or different than that selected for the second transmission of the second data.

51. A wireless device, for handling transmission, the wireless device being configured to operate in a wireless communications network, and the wireless device being further configured to:
after a first transmission of first data in a first subset of a set of periodic uplink time-frequency resources for uplink communication to a network node, wherein a size of a buffer of the wireless device for the uplink transmission of the first data is configured to be smaller than a threshold, and, in the absence of having received an acknowledgement from the network node that the first data has been received,
a. select a procedure for sending a second transmission to the network node the procedure being configured to be one of:
i. a Hybrid Automatic Repeat reQuest, HARQ retransmission,
ii. an initial transmission configured to comprise a same message to resume communications as a message to resume communications configured to be comprised in the first transmission,
iii. the initial transmission being configured to comprise the same message to resume communications and at least one of: a Medium Access Control Protocol Data Unit, MAC PDU, an updated MAC PDU, an updated report on a status of the buffer of the wireless device with respect to a report on the status of the buffer of the wireless device configured to be comprised in the first transmission, and an updated report on the power of the wireless device with respect to a report on the power of the wireless device configured to be comprised in the first transmission, and
iv. a random access or random access of small data transmission for the transmission of the data, and
b. send the second transmission to the network node, the sending of the second transmission being configured to be in a second subset of the set of periodic uplink time-frequency resources, the second subset being configured to be a next subset of the first subset.

52. The wireless device of claim 51, and wherein the selecting is configured to be based on at least one of:
a. whether or not a configured timer is configured and running,
b. a periodicity of the set of periodic uplink time-frequency resources for uplink communication to the network node of data, wherein the size of the buffer of the wireless device for the uplink transmission of the data is smaller than the threshold,
c. whether or not second data is obtained before a subsequent subset of the set of periodic uplink time-frequency resources for uplink communication to the network node of the data for the same HARQ process,
d. whether or not the second data is obtained resulting in a different Buffer Size for the report on the status of the buffer of the wireless device before the next subset of periodic uplink time-frequency resources for uplink communication to the network node of the data for the same HARQ process,
e. a priority of the second data,
f. whether or not the power headroom changes before the next subset of periodic uplink time-frequency resources for uplink communication to the network node of the data for the same HARQ process, and
g. a first configuration, the first configuration indicating that the HARQ retransmission or the initial transmission comprising the same message to resume communications is always selected.

53. The wireless device of claim 51, wherein the first transmission and the second transmission are configured to belong to a same HARQ process.

54. The wireless device of claim 51, being further configured to:
a. send the first transmission, the first transmission being configured to further comprise at least one of: the message to resume communications, the report on the status of the buffer of the wireless device, and the report on the power of the wireless device, and
b. obtain second data, and
wherein the selecting the procedure is configured to be performed after obtaining the second data.

55. The wireless device of claim 54, being further configured to:
a. repeat the obtaining, the selecting and the sending for third data, and wherein the procedure for transmission of the third data configured to be selected is configured to be one of: the same or different than that configured to be selected for the second transmission.

56. The wireless device of claim 51, wherein, with the proviso that only the report on the status of the buffer of the wireless device is able to be updated for the initial transmission comprising the MAC PDU, the selecting is configured to be performed autonomously by the wireless device.
